(19) United States
(12) Patent Application Publication
(10) Pub. No.: US 2026/0120410 A1
(43) Pub. Date: Apr. 30, 2026

(54) Selecting a User Computing Device or Server Computing System to Perform Rendering Operations Based on Rendering Criteria

(71) Applicant: Google LLC, Mountain View, CA (US)

(72) Inventor: Daniel Joseph Filip, San Jose, CA (US)

(21) Appl. No.: 18/930,347

(22) Filed: Oct. 29, 2024

(51) Int. Cl. G06T 19/00; G06F 3/14

(52) U.S. Cl. CPC G06T 19/00; G06F 3/14; G06T 2200/24

(57) ABSTRACT

Rendering operations associated with an interactive three-dimensional (3D) scene of a location can be selectively performed by at least one of a first computing system or a second computing system. A computing system includes one or more memories to store instructions and one or more processors to execute the instructions to perform operations, the operations including: selecting, based on whether one or more rendering criteria are satisfied, at least one of the first computing system or a second computing system to perform one or more rendering operations with respect to a plurality of visual elements associated with an interactive three-dimensional (3D) scene of a location, to generate a plurality of rendered visual elements; and providing, for presentation via the display device, the interactive 3D scene of the location, based on the plurality of rendered visual elements.

### FIELD

This disclosure relates generally to rendering an interactive three-dimensional (3D) scene of a location. More particularly, the disclosure relates to selecting at least one of a first computing system (e.g., a user computing device such as a smartphone) or a second computing system (e.g., a server computing system) to perform rendering operations associated with the interactive 3D scene of the location based on certain rendering criteria.

### BACKGROUND

Existing methods for rendering content include a server computer system that renders scenes and streams pixels to an end user device. If the server computing system does not have an available computing resource to render the scene (e.g., a graphics processing unit), the end user device may not be able to receive the streamed content, or there may be a delay in the end user device receiving the streamed content. If the network connection between the server computing system and the end user device is poor or disrupted, then the end user device may not be able to receive the streamed content.

### SUMMARY

Aspects and advantages of embodiments of the disclosure will be set forth in part in the following description, or can be learned from the description, or can be learned through practice of the embodiments.

Example aspects of the disclosure provide an example computing system or computing device (e.g., a user computing device) that includes one or more processors and one or more example non-transitory computer-readable media storing instructions that are executable by the one or more processors to cause the computing system or device to perform example operations. In some implementations, the example operations can include selecting, based on whether one or more rendering criteria are satisfied, at least one of the first computing system or a second computing system to perform one or more rendering operations with respect to a plurality of visual elements associated with an interactive three-dimensional (3D) scene of a location, to generate a plurality of rendered visual elements; and providing, for presentation via the display device, the interactive 3D scene of the location, based on the plurality of rendered visual elements.

In some implementations, the second computing system has a higher processing power than the first computing system, when the one or more rendering criteria are satisfied, selecting the first computing system to perform the one or more rendering operations; and when the one or more rendering criteria are not satisfied, selecting the second computing system to perform the one or more rendering operations, and receiving, from the second computing system, the plurality of rendered visual elements from the second computing system.

In some implementations, providing, for presentation via the display device, the interactive 3D scene of the location, based on the plurality of rendered visual elements comprises providing a user interface including the interactive 3D scene of the location and at least one selectable user interface element configured to control a view of the interactive 3D scene of the location, the one or more rendering criteria includes whether the at least one selectable user interface element is selected, and in response to receiving a selection of the at least one selectable user interface element, selecting the second computing system to perform one or more subsequent rendering operations.

In some implementations, the one or more rendering criteria includes whether a size of information associated with the interactive 3D scene to be rendered is greater than a threshold level, and in response to determining the size of the information associated with the interactive 3D scene to be rendered is greater than the threshold level, selecting the second computing system to initially perform the one or more rendering operations with respect to the plurality of visual elements associated with the interactive 3D scene of the location while the information associated with the interactive 3D scene is transmitted from the second computing system to the first computing system, and in response to completion of the information associated with the interactive 3D scene being transmitted to the first computing system, switching to the first computing system to perform any remaining rendering operations among the one or more rendering operations with respect to the plurality of visual elements associated with the interactive 3D scene of the location.

In some implementations, the one or more rendering criteria includes whether a processing power of the first computing system meets processing power criteria, in response to determining the processing power of the first computing system meets the processing power criteria, selecting the first computing system to perform the one or more rendering operations, and in response to determining the processing power of the first computing system does not meet the processing power criteria, selecting the second computing system to perform the one or more rendering operations.

In some implementations, the one or more rendering criteria includes whether the first computing system stores a 3D graphics library, in response to determining the first computing system stores the 3D graphics library, selecting the first computing system to perform the one or more rendering operations, and in response to determining the first computing system does not store the 3D graphics library, selecting the second computing system to perform the one or more rendering operations.

In some implementations, the one or more rendering criteria includes whether the second computing system has a particular computing resource available to perform the one or more rendering operations, in response to determining the second computing system does not have the particular computing resource available to perform the one or more rendering operations, selecting the first computing system to perform the one or more rendering operations, and in response to determining the second computing system has the particular computing resource available to perform the one or more rendering operations, selecting the second computing system to perform the one or more rendering operations.

In some implementations, in response to the particular computing resource subsequently becoming available after determining the second computing system does not have the particular computing resource available to perform the one or more rendering operations, switching to the first computing system to perform any remaining rendering operations among the one or more rendering operations with respect to the plurality of visual elements associated with the interactive 3D scene of the location.

In some implementations, the operations further comprise placing a reservation for the particular computing resource in response to determining the second computing system does not have the particular computing resource available to perform the one or more rendering operations, and in response to the particular computing resource subsequently becoming available according to the reservation, switching to the second computing system to perform any remaining rendering operations among the one or more rendering operations with respect to the plurality of visual elements associated with the interactive 3D scene of the location.

In some implementations, the one or more rendering criteria includes whether a network connection condition associated with a network connecting the first computing system and the second computing system meets particular network criteria and whether a size of information associated with the interactive 3D scene to be rendered is greater than a threshold level, in response to determining the network connection condition meets the particular network criteria or the size of the information associated with the interactive 3D scene to be rendered is less than the threshold level, selecting the first computing system to perform the one or more rendering operations, and in response to determining the network connection condition does not meet the particular network criteria and the size of the information associated with the interactive 3D scene to be rendered is greater than the threshold level, selecting the second computing system to perform the one or more rendering operations while the information associated with the interactive 3D scene is transmitted from the second computing system to the first computing system.

In some implementations, in response to completion of the information associated with the interactive 3D scene being transmitted to the first computing system, switching to the first computing system to perform any remaining rendering operations among the one or more rendering operations.

In some implementations, providing, for presentation via the display device, the interactive 3D scene of the location, based on the plurality of rendered visual elements comprises providing a user interface including the interactive 3D scene of the location and at least one selectable user interface element configured to select a fidelity level of the interactive 3D scene of the location to be displayed, the one or more rendering criteria includes whether the fidelity level selected via the at least one selectable user interface element is greater than a threshold fidelity level, and in response to the fidelity level selected via the at least one selectable user interface element being greater than the threshold fidelity level, selecting the second computing system to perform the one or more rendering operations.

In some implementations, the one or more rendering criteria includes whether a particular frame associated with the interactive 3D scene includes at least some content having a complexity level greater than a threshold complexity level, in response to determining the particular frame associated with the interactive 3D scene includes at least some content having the complexity level greater than the threshold complexity level, selecting the first computing system to perform the one or more rendering operations for a first portion of the particular frame and selecting the second computing system to perform the one or more rendering operations for a second portion of the particular frame, and content in the first portion of the particular frame does not have the complexity level greater than the threshold complexity level and content in the second portion of the particular frame has the complexity level greater than the threshold complexity level.

Example aspects of the disclosure provide an example computer-implemented method. In some implementations, the example computer-implemented method can include: selecting, by a first computing system comprising one or more processors, based on whether one or more rendering criteria are satisfied, at least one of the first computing system or a second computing system to perform one or more rendering operations with respect to a plurality of visual elements associated with an interactive three-dimensional (3D) scene of a location, to generate a plurality of rendered visual elements; and providing, for presentation via a display device of the first computing system, the interactive 3D scene of the location, based on the plurality of rendered visual elements.

In some implementations, providing, for presentation via the display device of the first computing system, the interactive 3D scene of the location, based on the plurality of rendered visual elements comprises providing a user interface including the interactive 3D scene of the location and at least one selectable user interface element configured to control a view of the interactive 3D scene of the location, the one or more rendering criteria includes whether the at least one selectable user interface element is selected, and the method comprises in response to receiving a selection of the at least one selectable user interface element, selecting the second computing system to perform one or more subsequent rendering operations.

In some implementations, the one or more rendering criteria includes whether a size of information associated with the interactive 3D scene to be rendered is greater than a threshold level, and the computer-implemented method includes: in response to determining the size of the information associated with the interactive 3D scene to be rendered is greater than the threshold level, selecting the second computing system to initially perform the one or more rendering operations with respect to the plurality of visual elements associated with the interactive 3D scene of the location while the information associated with the interactive 3D scene is transmitted from the second computing system to the first computing system, and in response to completion of the information associated with the interactive 3D scene being transmitted to the first computing system, switching to the first computing system to perform any remaining rendering operations among the one or more rendering operations with respect to the plurality of visual elements associated with the interactive 3D scene of the location.

In some implementations, the one or more rendering criteria includes whether a processing power of the first computing system meets processing power criteria, and the computer-implemented method includes: in response to determining the processing power of the first computing system meets the processing power criteria, selecting the first computing system to perform the one or more rendering operations, and in response to determining the processing power of the first computing system does not meet the processing power criteria, selecting the second computing system to perform the one or more rendering operations.

In some implementations, the one or more rendering criteria includes whether the second computing system has a particular computing resource available to perform the one or more rendering operations, and the computer-implemented method includes: in response to determining the second computing system does not have the particular computing resource available to perform the one or more rendering operations, selecting the first computing system to perform the one or more rendering operations, and in response to determining the second computing system has the particular computing resource available to perform the one or more rendering operations, selecting the second computing system to perform the one or more rendering operations.

In some implementations, the one or more rendering criteria includes whether a particular frame associated with the interactive 3D scene includes at least some content having a complexity level greater than a threshold complexity level, and the computer-implemented method includes: in response to determining the particular frame associated with the interactive 3D scene includes at least some content having the complexity level greater than the threshold complexity level, selecting the first computing system to perform the one or more rendering operations for a first portion of the particular frame and selecting the second computing system to perform the one or more rendering operations for a second portion of the particular frame, and content in the first portion of the particular frame does not have the complexity level greater than the threshold complexity level and content in the second portion of the particular frame has the complexity level greater than the threshold complexity level.

The computer-implemented method may execute any of the operations of the computing system or computing device as described herein.

Example aspects of the disclosure provide one or more example non-transitory computer-readable media storing instructions that are executable by one or more processors to cause a computing system to perform example operations. In some implementations, the example operations can include selecting, based on whether one or more rendering criteria are satisfied, at least one of the first computing system or a second computing system to perform one or more rendering operations with respect to a plurality of visual elements associated with an interactive three-dimensional (3D) scene of a location, to generate a plurality of rendered visual elements; and providing, for presentation via the display device, the interactive 3D scene of the location, based on the plurality of rendered visual elements.

The non-transitory computer-readable medium may store additional instructions to execute other aspects and operations of the computing system or computing device and computer-implemented method as described herein.

Example aspects of the disclosure provide an example computing system or computing device (e.g., a server computing system) that includes one or more processors and one or more example non-transitory computer-readable media storing instructions that are executable by the one or more processors to cause the computing system or device to perform example operations. In some implementations, the example operations can include determining whether one or more rendering criteria related to performing one or more rendering operations with respect to a plurality of visual elements associated with an interactive three-dimensional (3D) scene of a location, are satisfied; in response to determining the one or more rendering criteria related to performing the one or more rendering operations are satisfied, selecting a second computing system to perform the one or more rendering operations and transmitting the plurality of visual elements associated with the interactive 3D scene of the location from the first computing system to the second computing system for rendering; and in response to determining the one or more rendering criteria related to performing the one or more rendering operations are not satisfied, performing, by the first computing system, the one or more rendering operations to generate a plurality of rendered visual elements and transmitting the plurality of rendered visual elements to the second computing system.

In some implementations, the first computing system has a higher processing power than the second computing system.

In some implementations, when the second computing system displays a user interface including the interactive 3D scene of the location and at least one selectable user interface element configured to control a view of the interactive 3D scene of the location, the one or more rendering criteria includes whether the at least one selectable user interface element is selected, and in response to receiving a selection of the at least one selectable user interface element, selecting the first computing system to perform one or more subsequent rendering operations.

In some implementations, the one or more rendering criteria includes whether a size of information associated with the interactive 3D scene to be rendered is greater than a threshold level, and in response to determining the size of the information associated with the interactive 3D scene to be rendered is greater than the threshold level, selecting the first computing system to initially perform the one or more rendering operations with respect to the plurality of visual elements associated with the interactive 3D scene of the location while the information associated with the interactive 3D scene is transmitted from the first computing system to the second computing system, and in response to completion of the information associated with the interactive 3D scene being transmitted to the second computing system, switching to the second computing system to perform any remaining rendering operations among the one or more rendering operations with respect to the plurality of visual elements associated with the interactive 3D scene of the location.

In some implementations, the one or more rendering criteria includes whether a processing power of the second computing system meets processing power criteria, in response to determining the processing power of the second computing system meets the processing power criteria, selecting the second computing system to perform the one or more rendering operations, and in response to determining the processing power of the second computing system does not meet the processing power criteria, selecting the first computing system to perform the one or more rendering operations.

In some implementations, the one or more rendering criteria includes whether the second computing system stores a 3D graphics library, in response to determining the second computing system stores the 3D graphics library, selecting the second computing system to perform the one or more rendering operations, and in response to determining the second computing system does not store the 3D graphics library, selecting the first computing system to perform the one or more rendering operations.

In some implementations, the one or more rendering criteria includes whether the first computing system has a particular computing resource available to perform the one or more rendering operations, in response to determining the first computing system does not have the particular computing resource available to perform the one or more rendering operations, selecting the second computing system to perform the one or more rendering operations, and in response to determining the first computing system has the particular computing resource available to perform the one or more rendering operations, selecting the first computing system to perform the one or more rendering operations.

In some implementations, in response to the particular computing resource subsequently becoming available after determining the first computing system does not have the particular computing resource available to perform the one or more rendering operations, switching to the first computing system to perform any remaining rendering operations among the one or more rendering operations with respect to the plurality of visual elements associated with the interactive 3D scene of the location.

In some implementations, the operations further comprise placing a reservation for the particular computing resource in response to determining the first computing system does not have the particular computing resource available to perform the one or more rendering operations, and in response to the particular computing resource subsequently becoming available according to the reservation, switching to the first computing system to perform any remaining rendering operations among the one or more rendering operations with respect to the plurality of visual elements associated with the interactive 3D scene of the location.

In some implementations, the one or more rendering criteria includes whether a network connection condition associated with a network connecting the first computing system and the second computing system meets particular network criteria and whether a size of information associated with the interactive 3D scene to be rendered is greater than a threshold level, in response to determining the network connection condition meets the particular network criteria or the size of the information associated with the interactive 3D scene to be rendered is less than the threshold level, selecting the second computing system to perform the one or more rendering operations, and in response to determining the network connection condition does not meet the particular network criteria and the size of the information associated with the interactive 3D scene to be rendered is greater than the threshold level, selecting the first computing system to perform the one or more rendering operations while the information associated with the interactive 3D scene is transmitted from the first computing system to the second computing system.

In some implementations, in response to completion of the information associated with the interactive 3D scene being transmitted to the second computing system, switching to the second computing system to perform any remaining rendering operations among the one or more rendering operations.

In some implementations, providing, for presentation via the display device, the interactive 3D scene of the location, based on the plurality of rendered visual elements comprises providing a user interface including the interactive 3D scene of the location and at least one selectable user interface element configured to select a fidelity level of the interactive 3D scene of the location to be displayed, the one or more rendering criteria includes whether the fidelity level selected via the at least one selectable user interface element is greater than a threshold fidelity level, and in response to the fidelity level selected via the at least one selectable user interface element being greater than the threshold fidelity level, selecting the second computing system to perform the one or more rendering operations.

In some implementations, the one or more rendering criteria includes whether a particular frame associated with the interactive 3D scene includes at least some content having a complexity level greater than a threshold complexity level, in response to determining the particular frame associated with the interactive 3D scene includes at least some content having the complexity level greater than the threshold complexity level, selecting the second computing system to perform the one or more rendering operations for a first portion of the particular frame and selecting the first computing system to perform the one or more rendering operations for a second portion of the particular frame, and content in the first portion of the particular frame does not have the complexity level greater than the threshold complexity level and content in the second portion of the particular frame has the complexity level greater than the threshold complexity level.

Example aspects of the disclosure provide example computer-implemented methods that can execute any of the operations of the computing system or computing device (e.g., server computing system) as described herein.

Example aspects of the disclosure provide one or more example non-transitory computer-readable media storing instructions that are executable by one or more processors to cause a computing system to perform example operations. The non-transitory computer-readable medium may store instructions to execute any of the operations of the computing system or computing device (e.g., server computing system) and/or computer-implemented methods as described herein.

Other example aspects of the disclosure are directed to other systems, methods, apparatuses, tangible non-transitory computer-readable media, and devices for performing functions described herein. These and other features, aspects, and advantages of various implementations will become better understood with reference to the following description and appended claims. The accompanying drawings, which are incorporated in and constitute a part of this specification, illustrate implementations of the disclosure and, together with the description, help explain the related principles.

### BRIEF DESCRIPTION OF THE DRAWINGS

FIG. 1A is an example system, according to one or more example embodiments of the disclosure;

FIG. 1B is an example block diagram of a computing system, according to one or more example embodiments of the disclosure;

FIGS. 2A-2F each illustrate a flow diagram of an example, non-limiting computer-implemented method, according to one or more example embodiments of the disclosure;

FIG. 3 illustrates an example block diagram of a system including a navigation application, according to one or more example embodiments of the disclosure;

FIGS. 4A-4B are example user interfaces depicting an example interactive three-dimensional scene of a location, according to one or more example embodiments of the disclosure;

FIGS. 5A-5B are example user interfaces depicting an example interactive three-dimensional scene of a location, according to one or more example embodiments of the disclosure;

FIG. 6 is a flow chart diagram illustrating an example method for training a machine-learned model according to example implementations of aspects of the disclosure;

FIG. 7 is a block diagram of an example processing flow for using machine-learned model(s) to process input(s) to generate output(s) according to example implementations of aspects of the disclosure;

FIG. 8 is a block diagram of an example sequence processing model according to example implementations of aspects of the disclosure;

FIG. 9 is a block diagram of an example technique for populating an example input sequence for processing by a sequence processing model according to example implementations of aspects of the disclosure;

FIG. 10 is a block diagram of an example model development platform according to example implementations of aspects of the disclosure;

FIG. 11 is a block diagram of an example training workflow for training a machine-learned model according to example implementations of aspects of the disclosure;

FIG. 12 is a block diagram of an inference system for operating one or more machine-learned model(s) to perform inference according to example implementations of aspects of the disclosure;

FIG. 13 is a block diagram of an example networked computing system according to example implementations of aspects of the disclosure;

FIG. 14 is a block diagram of an example computing device according to example implementations of aspects of the disclosure; and

FIG. 15 is a block diagram of an example computing device according to example implementations of aspects of the disclosure.

### DETAILED DESCRIPTION

Reference now will be made to embodiments of the disclosure, one or more examples of which are illustrated in the drawings, wherein like reference characters denote like elements. Each example is provided by way of explanation of the disclosure and is not intended to limit the disclosure. In fact, it will be apparent to those skilled in the art that various modifications and variations can be made to disclosure without departing from the scope or spirit of the disclosure. For instance, features illustrated or described as part of one embodiment can be used with another embodiment to yield a still further embodiment. Thus, it is intended that the disclosure covers such modifications and variations as come within the scope of the appended claims and their equivalents.

Rendering dynamic and complex information associated with a scene (e.g., an interactive three-dimensional scene) can require that such rendering be performed with a high frame rate and with sufficient resolution to be accurate and realistic, as well as useful and enjoyable for the end user.

Existing methods for generating content include a server computer system that renders scenes and streams pixels to an end user device. If the server computing system does not have an available computing resource to render the scene (e.g., a graphics processing unit), the end user device may not be able to receive the streamed content, or there may be a delay in the end user device receiving the streamed content. If the network connection between the server computing system and end user device is poor or disrupted

According to examples of the disclosure, a hybrid rendering scheme can be employed to selectively use a server computing system (e.g., a cloud graphics processing unit) or a user computing device to render an interactive three-dimensional scene. For example, in some implementations, the server computing system (e.g., a cloud graphics processing unit) can render the interactive three-dimensional scene and stream the visual elements (e.g., pixels) to the user computing device. In some implementations, the server computing system (e.g., a cloud graphics processing unit) can transmit information (data) associated with the interactive three-dimensional scene and the user computing device is configured to render the information with a graphics processing unit and/or a central processing unit of the user computing device to generate rendered visual elements (e.g., rendered pixels). Whether the server computing system or the user computing device performs the rendering operations can be determined dynamically (e.g., in real-time), for example, based on one or more rendering criteria.

In some implementations, the rendering criteria can include whether the user computing device has certain capabilities (e.g., whether the user computing device has a sufficiently powerful processing power or sufficiently powerful GPU. If the user computing device doesn't have a sufficiently powerful GPU then the server computing system can perform the rendering operations and transmit or stream the rendered content (e.g., rendered pixels) to the user computing device.

In some implementations, the rendering criteria can include whether there is an adequate network bandwidth for the network connection between the user computing device and the server computing system. If the user computing device doesn't have a sufficiently powerful GPU then the server computing system can perform the rendering operations and transmit or stream the rendered content (e.g., rendered pixels) to the user computing device.

In some implementations, the rendering criteria can include whether there is an available computing resource (e.g., a cloud GPU) at the server computing system for performing the rendering operations. If the server computing system doesn't have an available computing resource (e.g., a cloud GPU) then the user computing device can perform the rendering operations. For example, the user computing device can render the interactive three-dimensional scene until the computing resource at the server computing system becomes available. For example, the user computing device may render the interactive three-dimensional scene at a lower resolution or lower level of detail if the user computing device renders the interactive three-dimensional scene at a slower speed than the server computing system would if the computing resource were available.

In some implementations, the rendering criteria can include whether the data payload to be transmitted from the server computing system to the user computing device is expensive (e.g., greater than a threshold level). For example, if the data payload (e.g., an amount of information associated with the interactive three-dimensional scene) is greater than the threshold level, the server computing system may be configured to initially render the interactive three-dimensional scene until the data has been transmitted (e.g., downloaded) to the user computing device, and then the rendering operations can be switched to the user computing device.

In some implementations, certain features of an interactive three-dimensional scene may only be capable of being rendered at the server computing system. For example, the interactive three-dimensional scene may be displayed in a user interface where the user interface also includes one or more selectable user interface elements that, when selected, can control a view of the interactive three-dimensional scene. In some implementations, if the selectable user interface element is selected, then the server computing system can be selected to render the interactive three-dimensional scene (e.g., rendering can be switched from the user computing device to the server computing system).

In some implementations, an individual rendered frame associated with an interactive three-dimensional scene can be a composite of local and cloud rendered data where more expensive (more complex) overlays that require more data can be rendered at the server computing system and less expensive (less complex) content can be rendered at the user computing device.

One or more technical benefits of the disclosure include the efficient selection and use of computing resources between a first computing system and a second computing system for rendering content based on certain rendering criteria. In some implementations, the computing systems and methods described herein can improve the quality of the generated output content by providing, for example, more timely (quicker, lower latency) delivery of rendered content in addition to, or in the alternative, higher fidelity rendered content. For example, in some implementations the computing systems and methods described herein provide that a first computing system (e.g., a user computing device) can render an interactive 3D scene of a location (e.g., an image, a frame, a video such as an immersive video, etc.) rather than a second computing system (e.g., a server computing system), thereby increasing the availability of computing resources (e.g., GPUs) at the second computing system and conserving computing resources such as network resources (e.g., bandwidth). In some implementations, the computing systems and methods described herein provide that a user of a first computing system (e.g., a user computing device) can obtain a higher fidelity rendering of the interactive 3D scene of the location (e.g., an image, a frame, a video such as an immersive video, etc.) through selection of a user interface element provided via a user interface to request that the second computing system render the interactive 3D scene of the location. In some implementations, the computing systems and methods described herein can conserve computing resources (e.g., network resources such as bandwidth) by rendering content at the first computing system (e.g., the user computing device) instead of at the second computing system (e.g., the server computing system). For example, in existing methods if a user manipulates or interacts with an interactive 3D scene of a location (e.g., by providing an input such as a touch input to a user interface which can change a view of the 3D scene of the location), information associated with the input provided by the user must be transmitted to the second computing system and then the second computing system renders the updated view of the interactive 3D scene of the location. In contrast, according to the computing systems and methods described herein, if the first computing system can perform the rendering operations, when the user manipulates or interacts with the interactive 3D scene of the location, the information associated with the input provided by the user need not be transmitted to the second computing system and the first computing system can render the updated view of the interactive 3D scene of the location itself, thereby conserving computing resources such as network resources (e.g., bandwidth).

Further, in some implementations the availability of computing resources to provide rendered content can be increased (e.g., increased uptime of computing resources). In some implementations, the computing systems and methods described herein provide that the first computing system (e.g., a user computing device) can render the interactive 3D scene of the location when it is determined the second computing system (e.g., a server computing system) does not have an available computing resource (e.g., a GPU), thereby increasing uptime for displaying content. In other words, a navigation application and/or content generation application need not wait for the computing resource to become available at the second computing system. In some implementations, the computing systems and methods described herein provide that the first computing system (e.g., a user computing device) can obtain rendered content (e.g., a rendered interactive 3D scene of the location) while an expensive data payload (e.g., information associated with the interactive 3D scene) is being downloaded to the first computing system, for example, when it is determined the size of the data payload exceeds a threshold level. For example, a navigation application and/or content generation application of the first computing system (e.g., the user computing device) need not wait for the data to be downloaded before displaying rendered content. That is, the user can view rendered content while data is being downloaded in the background and then the rendering of the content for display at the first computing system can be smoothly transitioned to the first computing system. In some implementations, a frame can be rendered in a composite fashion where complex content within the frame can be rendered at the second computing system (e.g., a server computing system) while less complex content within the frame can be rendered at the first computing system (e.g., a user computing device), thereby efficiently allocating the use of these computing systems.

Therefore, aspects of the disclosure provide technical effects, benefits, and/or improvements in computing technology and the technology of content generation systems, navigation systems, etc., via one or more computing devices (e.g., a user computing device, a server computing system, and combinations thereof), as described herein.

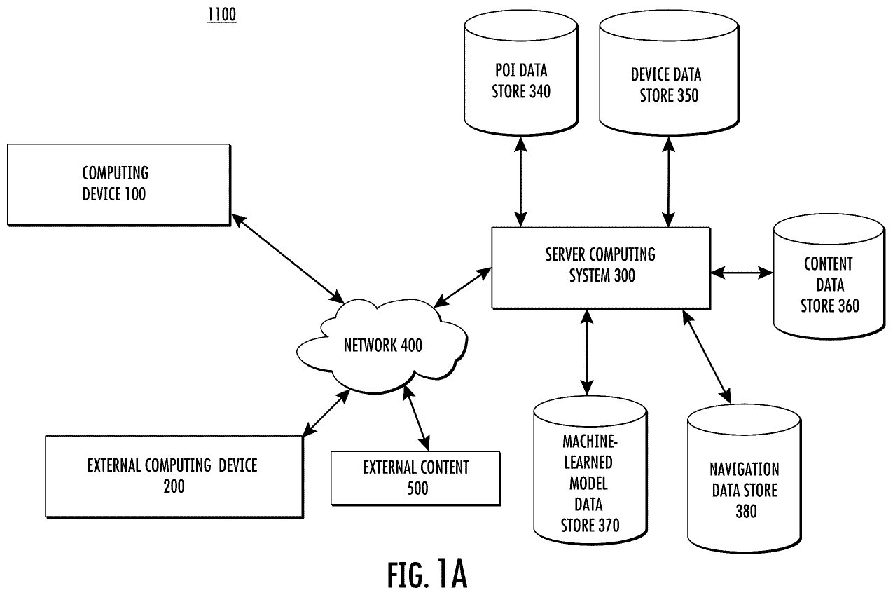

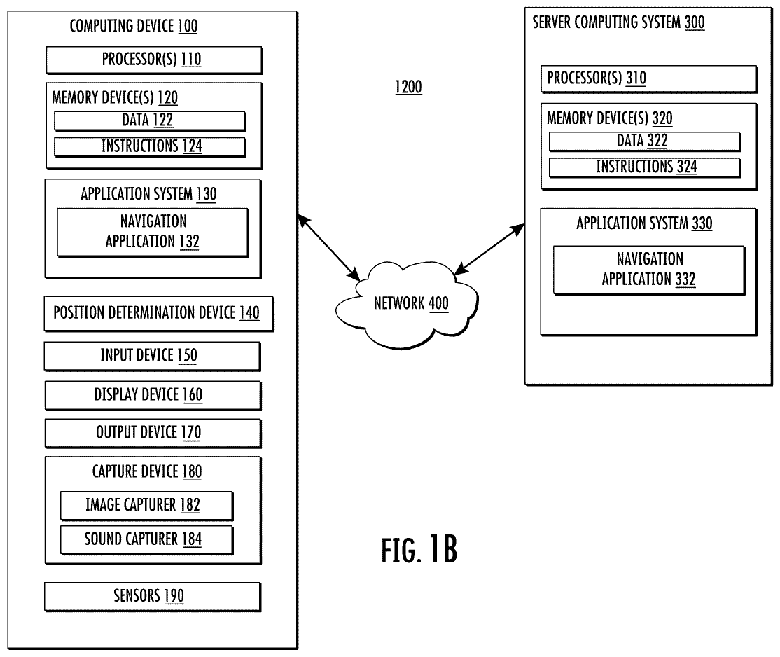

Referring now to the drawings, FIG. 1A is an example system according to one or more example embodiments of the disclosure. FIG. 1A illustrates an example of a system 1100 which includes a computing device 100, an external computing device 200, a server computing system 300, and external content 500, which may be in communication with one another over a network 400. For example, the computing device 100 and the external computing device 200 can serve as a local device or client device, and can include any of a personal computer, a smartphone, a tablet computer, a laptop, a global positioning service device, a smartwatch, and the like. The network 400 may include any type of communications network including a wired or wireless network, or a combination thereof. The network 400 may include a local area network (LAN), wireless local area network (WLAN), wide area network (WAN), personal area network (PAN), virtual private network (VPN), or the like. For example, wireless communication between elements of the example embodiments may be performed via a wireless LAN, Wi-Fi, Bluetooth, ZigBee, Wi-Fi direct (WFD), ultra wideband (UWB), infrared data association (IrDA), Bluetooth low energy (BLE), near field communication (NFC), a radio frequency (RF) signal, and the like. For example, wired communication between elements of the example embodiments may be performed via a pair cable, a coaxial cable, an optical fiber cable, an Ethernet cable, and the like. Communication over the network 400 can use a wide variety of communication protocols (e.g., TCP/IP, HTTP, SMTP, FTP), encodings or formats (e.g., HTML, XML), and/or protection schemes (e.g., VPN, secure HTTP, SSL).

As will be explained in more detail below, in some implementations the computing device 100 and/or server computing system 300 may form part of an application system which can render content in a hybrid fashion by which various rendering operations can be performed by the computing device 100 or the server computing system 300, based on whether certain rendering criteria are satisfied.

In some example embodiments, the server computing system 300 may obtain data from one or more of a POI data store 340, a device data store 350, a content data store 360, a machine-learned model data store 370, a navigation data store 380 to implement various operations and aspects of the application systems as disclosed herein. The POI data store 340, device data store 350, content data store 360, machine-learned model data store 370, and navigation data store 380 may be integrally provided with the server computing system 300 (e.g., as part of the one or more memory devices 320 of the server computing system 300) or may be separately (e.g., remotely) provided. Further, POI data store 340, device data store 350, content data store 360, machine-learned model data store 370, and navigation data store 380 can be combined as a single data store (database) or may include a plurality of respective data stores. Data stored in one data store (e.g., the POI data store 340) may overlap with some data stored in another data store (e.g., content data store 360). In some implementations, one data store (e.g., the machine-learned model data store 370) may reference data that is stored in another data store (e.g., the content data store 360).

In some implementations, the POI data store 340 can store information about locations or points-of-interest, for example, for points-of-interest in an area or region associated with one or more geographic areas. A point-of-interest may include any destination or place. For example, a point-of-interest may include a restaurant, museum, sporting venue, concert hall, amusement park, school, place of business, grocery store, gas station, theater, shopping mall, lodging, and the like. Point-of-interest data which is stored in the POI data store 340 may include any information which is associated with the POI. For example, the POI data store 340 may include location information for the POI, hours of operation for the POI, a phone number for the POI, reviews concerning the POI, financial information associated with the POI (e.g., the average cost for a service provided and/or goods sold at the POI such as a meal, a ticket, a room, etc.), environmental information concerning the POI (e.g., a noise level, an ambiance description, a traffic level, etc., which may be provided or available in real-time by various sensors located at the POI), a description of the types of services provided and/or goods sold, languages spoken at the POI, a URL for the POI, image content associated with the POI, etc. For example, information about the POI may be obtainable from external content 500 (e.g., from webpages associated with the POI or from sensors disposed at the POI).

In some implementations, the device data store 350 can store device information associated with various computing devices (e.g., a user computing device, a server computing system, etc.). For example, the device data store 350 can include device information relating to identifying the computing devices and/or information relating to capabilities or specifications of the computing devices. In some implementations, the device information can include a device part number, a device model number, a device name, a device manufacturer, date of manufacture, and the like. For example, the device data store 350 can include specification information about each of the computing devices. For example, the specification information can include information about the processing power of the computing device (e.g., available processors, model information of the processors, speed of the processors, etc.), memory capacity and speed information of the computing device, storage specifications, graphics processing unit specifications, display capabilities, network capabilities (e.g., ability to connect to Wi-Fi networks, cellular networks, etc.), operating system information, batter capacity and/or power information, version and/or date information associated with each of the components, etc.

In some implementations, the content data store 360 can store data associated with content. For example, the content can include images, videos, etc. In some implementations, the information stored in the content data store 360 can be associated with and/or stored according to a particular user or a plurality of users, according to a particular content category, content genre, content context, time, location, content type, content environment, etc. In some implementations, the information stored in the content data store 360 can be associated with and/or stored according to a particular entity that is associated with the content (e.g., an entity that requests the content to be generated, an entity that is to receive the content, an entity that appears in the content, etc.). For example, machine-learned models described herein can reference or retrieve content from the content data store 360 when generating or rendering content (e.g., an interactive three-dimensional scene of a location). The content which is referenced or retrieved from the content data store 360 may be associated with a location of the computing device 100.

Machine-learned model data store 370 can store machine-learned models which can be retrieved and implemented by the server computing system 300 for generating distilled or fine-tuned machine-learned models (e.g., distilled or fine-tuned generative machine-learned models) that, in some implementations, can also be provided to the computing device 100. Machine-learned model data store 370 can also store distilled or fine-tuned machine-learned models (e.g., distilled or fine-tuned generative machine-learned models) which can be retrieved and implemented by the computing device 100. In some implementations, the computing device 100 can retrieve and implement machine-learned models which are large parameter models that have not been fine-tuned or distilled. The machine-learned models (including large parameter models and distilled or fine-tuned models) stored at the machine-learned model data store 370 can include generative machine-learned models respectively associated with different types of applications, types of items, etc., that may be implemented across a variety of domains (e.g., navigation, mapping, healthcare, gaming, engineering/science, entertainment, travel, retail, etc.). The machine-learned models may include large language models and general, multimodal models (e.g., Gemini). The machine-learned models may include text-to-text large language models, text-to-image large language models, etc. The machine-learned models may include language models which have been trained using reinforcement learning from human feedback. The machine-learned models may include generative artificial intelligence (AI) models which may implement generative adversarial networks (GANs), transformers, variational autoencoders (VAEs), neural radiance fields (NeRFs), and the like.

Navigation data store 380 may store or provide map data/geospatial data to be used by server computing system 300 and/or computing device 100. Example geospatial data includes geographic imagery (e.g., digital maps, satellite images, aerial photographs, street-level photographs, synthetic models, etc.), tables, vector data (e.g., vector representations of roads, parcels, buildings, etc.), point of interest data, or other suitable geospatial data associated with one or more geographic areas. In some examples, the map data can include a series of sub-maps, each sub-map including data for a geographic area including objects (e.g., buildings or other static features), paths of travel (e.g., roads, highways, public transportation lines, walking paths, and so on), and other features of interest. Navigation data store 380 can be used by server computing system 300 and/or computing device 100 to provide navigational directions, perform point of interest searches, provide point of interest location or categorization data, determine distances, routes, or travel times between locations, or any other suitable use or task required or beneficial for performing operations of the example embodiments as disclosed herein.

For example, the navigation data store 380 may store 3D scene imagery or data which includes images or data associated with generating or rendering 3D scenes of various locations. For example, a 3D scene can be generated or rendered based on a plurality of images of a location (e.g., of the inside of a restaurant, of a park, of a road, etc.). The plurality of images may be captured and combined using known methods to create a 3D scene of the location. For example, images which overlap with one another may be stitched together to create a 3D model of the scene. In some implementations, a method including a structure from motion algorithm can be used to estimate a three-dimensional structure. In some implementations, one or more machine-learned models may be implemented to generate a camera-like image (e.g., an immersive view) from any viewpoint within the location based on the captured images. For example, video flythroughs of the location may be generated based on the captured images.

External content 500 can be any form of external content including news articles, webpages, image files, video files, audio files, written descriptions, ratings, game content, social media content, photographs, commercial offers, transportation method, weather conditions, sensor data obtained by various sensors, or other suitable external content. The computing device 100, external computing device 200, and server computing system 300 can access external content 500 over network 400. External content 500 can be searched by computing device 100, external computing device 200, and server computing system 300 according to known searching methods and search results can be ranked according to relevance, popularity, or other suitable attributes, including location-specific filtering or promotion.

FIG. 1B is an example block diagram of a computing system, according to one or more example embodiments of the disclosure. Referring now to FIG. 1B, example block diagrams of a system 1200 including a computing device 100 and server computing system 300 according to one or more example embodiments of the disclosure will now be described. Although computing device 100 is represented in FIG. 1B, features of the computing device 100 described herein are also applicable to the external computing device 200.

The computing device 100 may include one or more processors 110, one or more memory devices 120, an application system 130, a position determination device 140, an input device 150, a display device 160, an output device 170, a capture device 180, and one or more sensors 190. The server computing system 300 may include one or more processors 310, one or more memory devices 320, and an application system 330.

For example, the one or more processors 110, 310 can be any suitable processing device that can be included in a computing device 100 or server computing system 300. For example, the one or more processors 110, 310 may include one or more of a processor, processor cores, a controller and an arithmetic logic unit, a central processing unit (CPU), a graphics processing unit (GPU), a digital signal processor (DSP), an image processor, a microcomputer, a field programmable array, a programmable logic unit, an application-specific integrated circuit (ASIC), a microprocessor, a microcontroller, etc., and combinations thereof, including any other device capable of responding to and executing instructions in a defined manner. The one or more processors 110, 310 can be a single processor or a plurality of processors that are operatively connected, for example in parallel.

The one or more memory devices 120, 320 can include one or more non-transitory computer-readable storage mediums, including a Read Only Memory (ROM), Programmable Read Only Memory (PROM), Erasable Programmable Read Only Memory (EPROM), and flash memory, a USB drive, a volatile memory device including a Random Access Memory (RAM), a hard disk, floppy disks, a Blu-ray disk, or optical media such as CD ROM discs and DVDs, and combinations thereof. However, examples of the one or more memory devices 120, 320 are not limited to the above description, and the one or more memory devices 120, 320 may be realized by other various devices and structures as would be understood by those skilled in the art.

For example, the one or more memory devices 120 can also include data 122 and instructions 124 that can be retrieved, manipulated, created, or stored by the one or more processors 110. In some example embodiments, such data can be accessed and used as input to implement navigation application 132, and to execute the instructions to perform operations including selecting, based on whether one or more rendering criteria are satisfied, at least one of the first computing system or a second computing system to perform one or more rendering operations with respect to a plurality of visual elements associated with an interactive three-dimensional (3D) scene of a location, to generate a plurality of rendered visual elements; and providing, for presentation via the display device, the interactive 3D scene of the location, based on the plurality of rendered visual elements, as described according to examples of the disclosure.

For example, the one or more memory devices 320 can also include data 322 and instructions 324 that can be retrieved, manipulated, created, or stored by the one or more processors 310. In some example embodiments, such data can be accessed and used as input to implement navigation application 332, and to execute the instructions to perform operations including determining, with respect to a plurality of visual elements associated with an interactive three-dimensional (3D) scene of a location, whether one or more rendering criteria related to performing one or more rendering operations with respect to the plurality of visual elements are satisfied; in response to determining the one or more rendering criteria related to performing the one or more rendering operations are satisfied, selecting a second computing system to perform the one or more rendering operations and transmitting the plurality of visual elements associated with the interactive 3D scene of the location from the first computing system to the second computing system for rendering; and in response to determining the one or more rendering criteria related to performing the one or more rendering operations are not satisfied, performing, by the first computing system, the one or more rendering operations to generate a plurality of rendered visual elements and transmitting the plurality of rendered visual elements to the second computing system, as described according to examples of the disclosure.

In some example embodiments, the computing device 100 includes an application system 130. For example, the application system 130 may include the navigation application 132. The application system 130 can include various other applications including content generation applications, search applications, gaming applications, document applications, text messaging applications, email applications, dictation applications, virtual keyboard applications, browser applications, map applications, social media applications, etc.

According to examples of the disclosure, the navigation application 132 may be executed by the computing device 100 to generate content relating to a geographic location (e.g., navigation directions to a point-of-interest, an immersive view about a geographic location, information about a point-of-interest, etc.). In some implementations, the navigation application 132 may be part of another application (e.g., a search application, health application, gaming application, etc.) or may be a standalone application. The navigation application 132 may be configured to be dynamically interactive according to various user inputs. Example implementations of the navigation application 132 are described herein, however the disclosure is not limited to these examples as various modifications may be made to the embodiments described herein.

In some examples, one or more aspects of the navigation application 132 may be implemented by the navigation application 332 of the server computing system 300 which may be remotely located, to provide a user of the computing device 100 a way to generate navigation information. In some examples, one or more aspects of the navigation application 332 may be implemented by the navigation application 132 of the computing device 100, to generate navigation information.

In some example embodiments, the computing device 100 includes a position determination device 140. Position determination device 140 can determine a current geographic location of the computing device 100 and communicate the geographic location to the server computing system 300 over network 400. The position determination device 140 can be any device or circuitry for analyzing the position of the computing device 100. For example, the position determination device 140 can determine actual or relative position by using a satellite navigation positioning system (e.g. a GPS system, a Galileo positioning system, the GLObal Navigation satellite system (GLONASS), the BeiDou Satellite Navigation and Positioning system), an inertial navigation system, a dead reckoning system, based on an IP address, by using triangulation and/or proximity to cellular towers or WiFi hotspots, and/or other suitable techniques for determining a position of the computing device 100. For example, in some implementations the navigation application 132 may be configured to utilize position information determined by the position determination device 140 to generate navigation directions, obtain current traffic conditions at a particular geographic location, etc.

The computing device 100 may include an input device 150 configured to receive an input from a user and may include, for example, one or more of a keyboard (e.g., a physical keyboard, virtual keyboard, etc.), a mouse, a joystick, a button, a switch, an electronic pen or stylus, a gesture recognition sensor (e.g., to recognize gestures of a user including movements of a body part), an input sound device or speech recognition sensor (e.g., a microphone to receive a voice input such as a voice command or a voice query), a track ball, a remote controller, a portable (e.g., a cellular or smart) phone, a tablet PC, a pedal or footswitch, a virtual-reality device, and so on. The input device 150 may also be embodied by a touch-sensitive display having a touchscreen capability, for example. For example, the input device 150 may be configured to receive an input from a user associated with the input device 150 for executing the navigation application 132, for providing an input prompt to the navigation application 132, for providing feedback to the navigation application 132, for communicating with other users, for accepting or declining suggestions or recommendations provided by the computing device 100, etc.

The computing device 100 may include a display device 160 which displays information viewable by the user (e.g., a user interface screen). For example, the display device 160 may be a non-touch sensitive display or a touch-sensitive display. The display device 160 may include a liquid crystal display (LCD), a light emitting diode (LED) display, an organic light emitting diode (OLED) display, active matrix organic light emitting diode (AMOLED), flexible display, 3D display, a plasma display panel (PDP), a cathode ray tube (CRT) display, and the like, for example. However, the disclosure is not limited to these example displays and may include other types of displays. The display device 160 can be used by the application system 130 provided at the computing device 100 to display information to a user relating to an interactive three-dimensional scene (e.g., an immersive view of a location), to display a user interface to a user including the interactive three-dimensional scene, etc. The display device 160 can be configured to provide, for presentation to a user, one or more user interface screens having user interface elements which are selectable by the user for generating content according to an input, for providing feedback or instructions (guidance) to a user regarding operations for controlling functions of the navigation application 132, for changing a view or orientation of the interactive three-dimensional scene, etc.

The computing device 100 may include an output device 170 to provide an output to the user and may include, for example, one or more of an audio device (e.g., one or more speakers), a haptic device to provide haptic feedback to a user (e.g., a vibration device), a light source (e.g., one or more light sources such as LEDs which provide visual feedback to a user), a thermal feedback system, and the like. For example, the output device 170 may provide information relating to operations for controlling or selecting functions of the navigation application 132, including an output confirming selections made by a user, an output relating to the interactive three-dimensional scene, an output for providing feedback or instructions (guidance) to a user regarding the interactive three-dimensional scene, etc.

The computing device 100 may include a capture device 180 that is capable of capturing media content, according to various examples of the disclosure. For example, the capture device 180 can include an image capturer 182 (e.g., a camera) which is configured to capture images (e.g., photos, video, and the like). For example, the image capturer 182 can include one or more cameras having an imaging sensor (e.g., a complementary metal-oxide-semiconductor (CMOS) or charge-coupled device (CCD)). For example, the capture device 180 can include a sound capturer 184 (e.g., a microphone) which is configured to capture sound or audio (e.g., an audio recording). The media content captured by the capture device 180 may be transmitted to one or more of the server computing system 300, POI data store 340, device data store 350, content data store 360, machine-learned model data store 370, navigation data store 380 for example, via network 400. For example, in some implementations, content which is captured by the capture device 180 may be provided as an input to the application system 130 (e.g., the navigation application 132) to indicate a status of a user, a location, and/or of the computing device 100.

The computing device 100 may include one or more sensors 190. For example, the one or more sensors 190 may include an inertial measurement unit which includes one or more accelerometers and/or one or more gyroscopes. The one or more accelerometers and one or more gyroscopes may be used to capture motion information with respect to the computing device 100. The motion information obtained via the inertial measurement unit may be associated with the user when the computing device 100 is worn or carried by the user. For example, the one or more sensors 190 may include one or more optical sensors (e.g., one or more photoplethysmography (PPG) sensors, one or more electrocardiogram sensors, etc.). The one or more sensors 190 may also include other sensors such as a magnetometer, proximity sensor, Hall effect sensor, and the like. For example, in some implementations, content which is captured by the one or more sensors 190 may be provided as an input to the application system 130 (e.g., the navigation application 132) to indicate a status of a user, a location, and/or of the computing device 100. For example, weather conditions (e.g., temperature, wind, precipitation, etc.) measured by various weather sensors of the computing device 100 may be referenced by the application system 130 (e.g., the navigation application 132) to determine or generate content for operations associated with providing navigation information to a user.

In accordance with example embodiments of the disclosure, the server computing system 300 can be a remote device that is remotely located from the computing device 100. The server computing system 300 can include one or more processors 310 and one or more memory devices 320 as described herein. The server computing system 300 may also include an application system 330 which is similar to the application system 130 described herein.

For example, the application system 330 may include the navigation application 332 which performs functions similar to those described herein with respect to navigation application 132. In some implementations, the navigation application 332 may be part of another application (e.g., a search application, health application, gaming application, content generation application, etc.) or may be a standalone application.

Examples of the disclosure are directed to computer implemented methods for application systems, for example application systems including navigation applications, which are configured to provide a view or video including an interactive three-dimensional scene of a location by selectively rendering data associated with the view or video at a first computing system (first rendering system) and/or a second computing system (second rendering system) according to whether certain rendering criteria are satisfied.

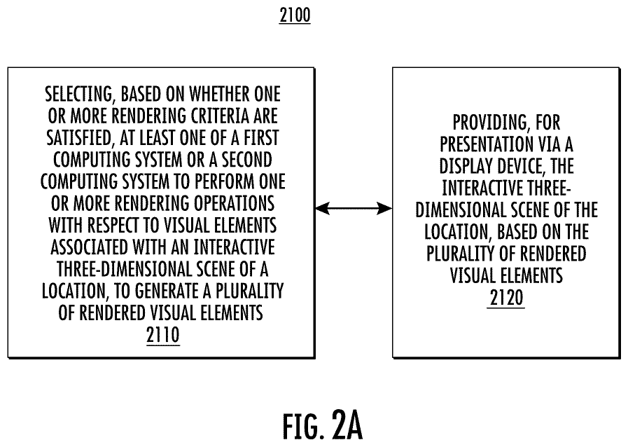

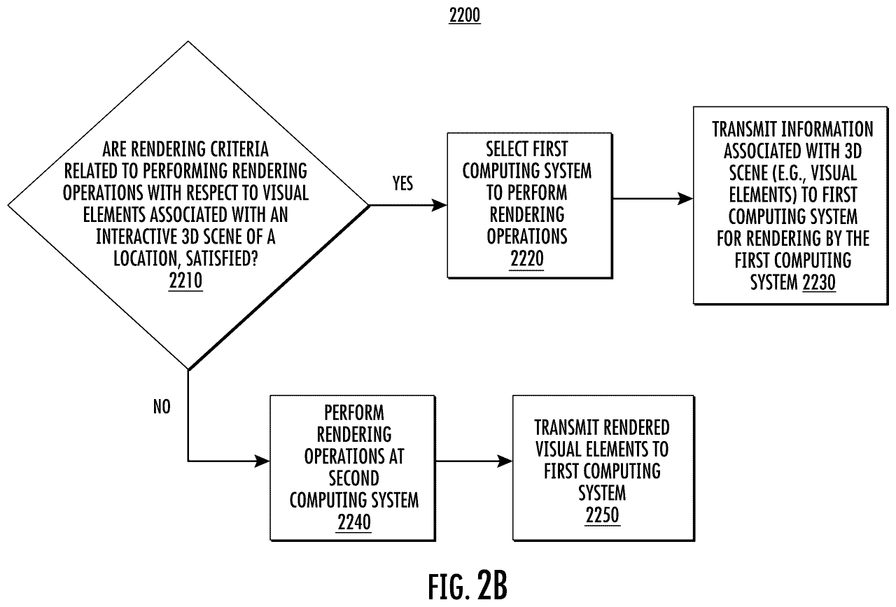

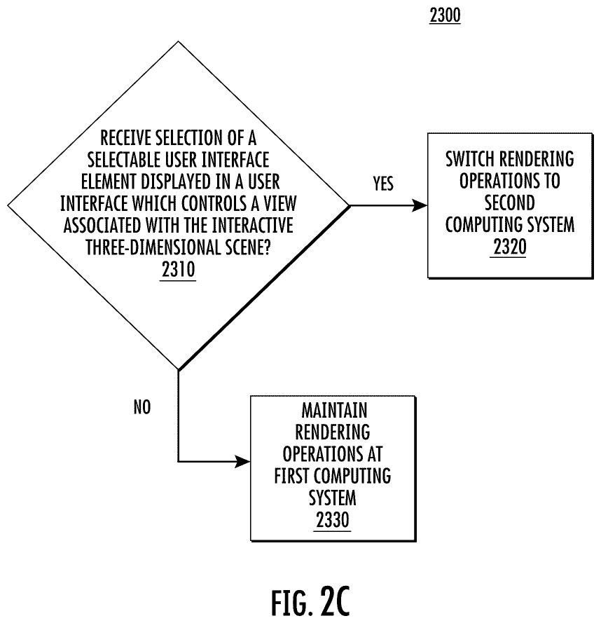

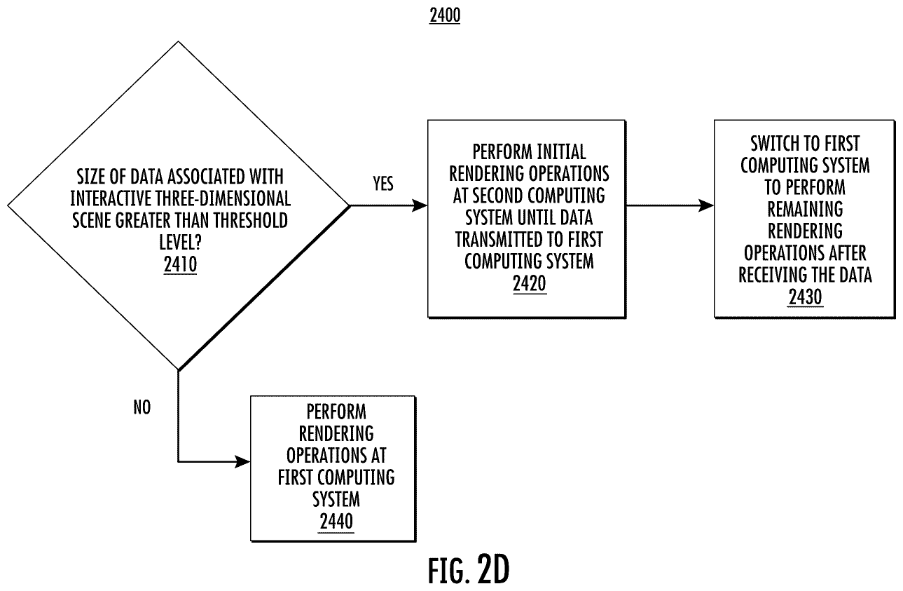

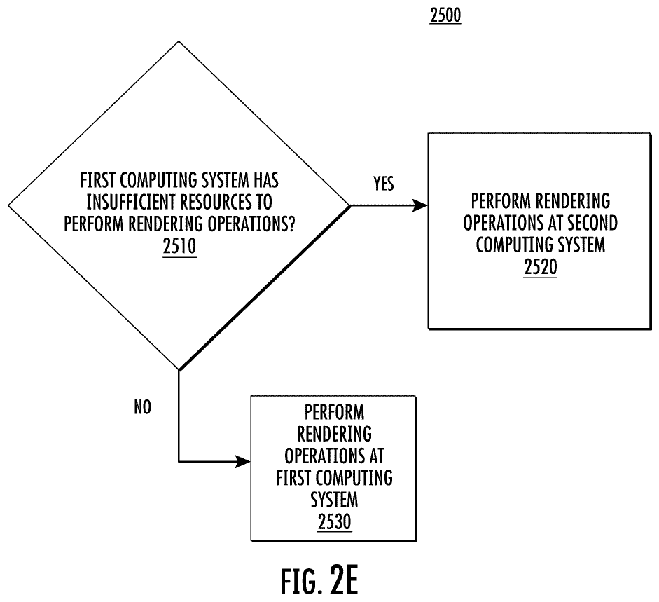

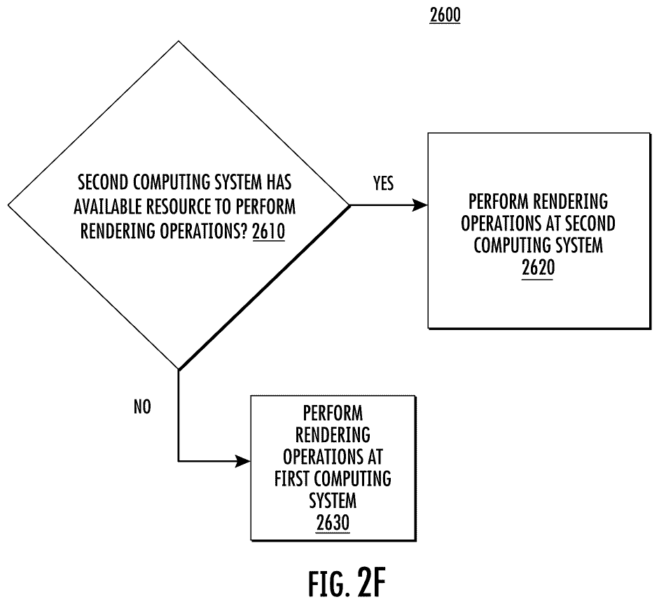

The flow diagrams of FIGS. 2A through 2F illustrate various methods for providing, for presentation at a first computing system, an interactive three-dimensional scene, based on visual elements which are rendered at the first computing system and/or a second computing system according to whether certain rendering criteria are satisfied. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

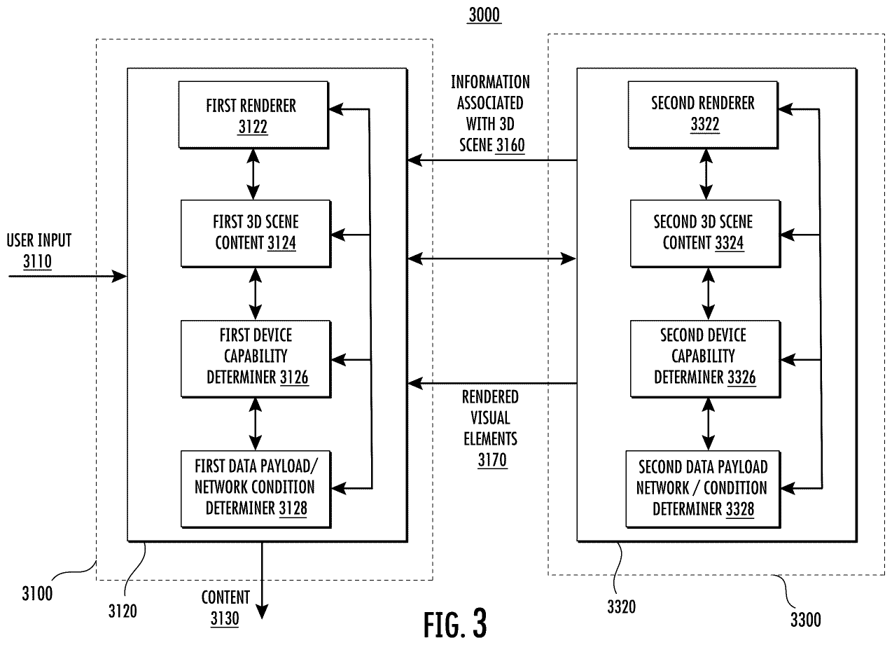

The operations of FIG. 2A through 2F will be explained with reference to FIG. 3. FIG. 3 illustrates an example block diagram or architecture of an environment including a first computing system and a second computing system, according to one or more example embodiments of the disclosure.

Referring to FIG. 2A, at operation 2110 the method 2100 includes a first computing system selecting, based on whether one or more rendering criteria are satisfied, at least one of the first computing system or a second computing system to perform one or more rendering operations with respect to a plurality of visual elements associated with an interactive three-dimensional (3D) scene of a location, to generate a plurality of rendered visual elements. As described herein, the first computing system may be embodied as computing device 100, for example. In the environment 3000 of FIG. 3, a first computing system 3100 (which can correspond to computing device 100 that serves as a local device, client device, end user device, etc.) communicates with a remotely located second computing system 3300 (which can correspond to server computing system 300 that serves as a remote device). In some implementations the first computing system 3100 may be configured to receive a user input 3110 to execute a first application 3120 (e.g., a navigation application) that is configured to display the interactive 3D scene (e.g., a video comprising a plurality of frames which include a sequence of three-dimensional scenes). As an example, a user may want to know more about a geographic location or point-of-interest and the user provides one or more inputs to execute the first application 3120 to obtain information about the geographic location or point-of-interest. The input may be a text input or voice input, for example (e.g., “tell me what traffic is like downtown at 11 am,” “give me directions to the wharf,” etc.). The first application 3120 may be configured to launch and can automatically generate the information (e.g., the directions, an image or video of the location, etc.) for output to the user of the first computing system 3100. In some implementations, the first application 3120 may be configured to provide, for presentation at a display device (e.g., display device 160) the interactive 3D scene of the location in the form of an immersive video. The first application 3120 can interact with or communicate with the second application 3320, as described herein. For example, determinations regarding whether the rendering criteria are satisfied can be made (e.g., by the first computing system 3100 and/or the second computing system 3300) in real-time. In some implementations, in a default mode the first computing system 3100 can be selected (e.g., by the first computing system 3100 and/or the second computing system 3300) as the computing system to perform the rendering operations.

According to examples of the disclosure, according to whether certain rendering criteria are satisfied, the output content including the interactive 3D scene of the location can be rendered (e.g., in real-time) and output (e.g., in real-time) at the first computing system 3100 and/or the output content including the interactive 3D scene of the location can be requested from the second computing system 3300 and the second computing system 3300 can render (e.g., in real-time) the output content and stream the rendered visual elements to the first computing system 3100 (e.g., in real-time). In some implementations, the second computing system 3300 (which can correspond to the server computing system 300) has a higher processing power than the first computing system 3100. In some implementations, when the one or more rendering criteria are satisfied, the first computing system 3100 can be selected (e.g., by the first computing system 3100) to perform one or more rendering operations associated with the interactive 3D scene of the location, to generate a plurality of rendered visual elements, and when the one or more rendering criteria are not satisfied, the second computing system 3300 can be selected (e.g., by the first computing system 3100) to perform the one or more rendering operations, and rendered visual elements can be received by the first computing system 3100 from the second computing system 3300. For example, the visual elements can correspond to pixels, sub-pixels, voxels, or other units of visual representation that compose or form an image (e.g., a 3D scene).

FIG. 2C illustrates an example method 2300 for determining whether rendering criteria are satisfied for selecting the first computing system 3100 and/or the second computing system 3300 to render visual elements associated with an interactive 3D scene, according to examples of the disclosure. In some implementations, the interactive 3D scene can be displayed in a user interface and the user interface can also include one or more user interface elements. One or more of the user interface elements can be selectable for controlling a view, orientation, etc. of the interactive 3D scene. In some implementations, if the first computing system 3100 is performing rendering operations and a particular feature in the user interface is selected (e.g., a user interface element that is selectable for controlling a view, orientation, etc. of the interactive 3D scene), the rendering operations can be switched to the second computing system 3300 for performing subsequent rendering operations. For example, at operation 2310 the first computing system 3100 (or in some implementations the second computing system 3300) can determine whether a selection of a selectable user interface element displayed in a user interface which controls a view or orientation associated with the interactive three-dimensional scene is received by the first computing system 3100. At operation 2320, if it is determined that the selection of the selectable user interface element is received by the first computing system 3100, the rendering operations can be switched to the second computing system 3300. At operation 2330, if it is determined that the selection of the selectable user interface element is not received by the first computing system 3100, the rendering operations can be maintained at the first computing system 3100.

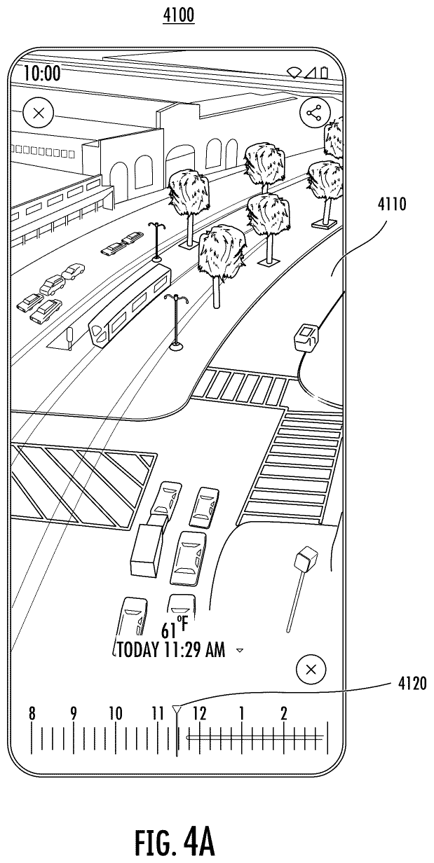

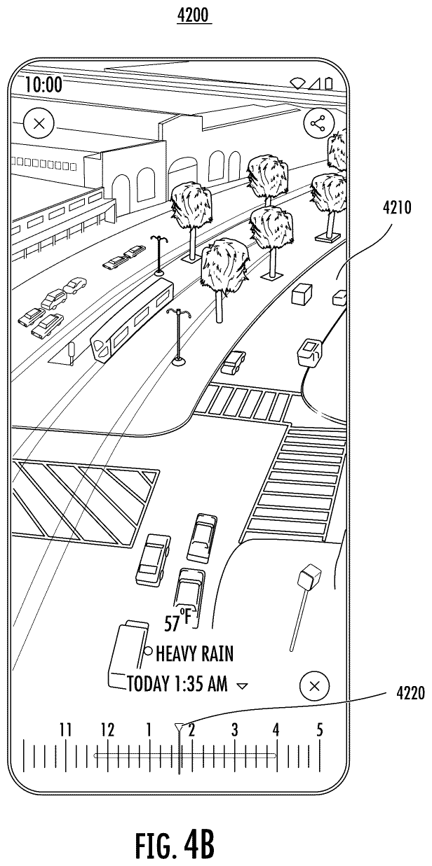

As an example, FIGS. 4A-4B are example user interfaces depicting an example interactive three-dimensional scene of a location, according to one or more example embodiments of the disclosure. In FIG. 4A, a first user interface 4100 includes content (e.g., an interactive 3D scene) which is rendered by the first computing system 3100, including first content 4110 which shows a 3D scene with a depiction of traffic at a particular geographic location at a particular time of day (e.g., 11:29 am) and a user interface element 4120 which is selectable for changing a view of the interactive 3D scene. For example, a user can select the user interface element 4120 (e.g., a slider bar) to obtain information regarding the geographic location at another time of day, thereby changing a view of the 3D scene. In response to receiving the selection of the user interface element 4120, rendering operations can be switched to the second computing system 3300 to perform one or more subsequent rendering operations. For example, in FIG. 4B a second user interface 4200 includes content (e.g., an interactive 3D scene) which has been rendered by the first computing system 3100, including second content 4210 which shows a subsequent 3D scene with a subsequent depiction of traffic at the particular geographic location at a later time in the day (e.g., at 1:35 pm) and where the user interface element 4220 which is selectable for changing a view of the interactive 3D scene has been shifted to the later time (e.g., via a user input).

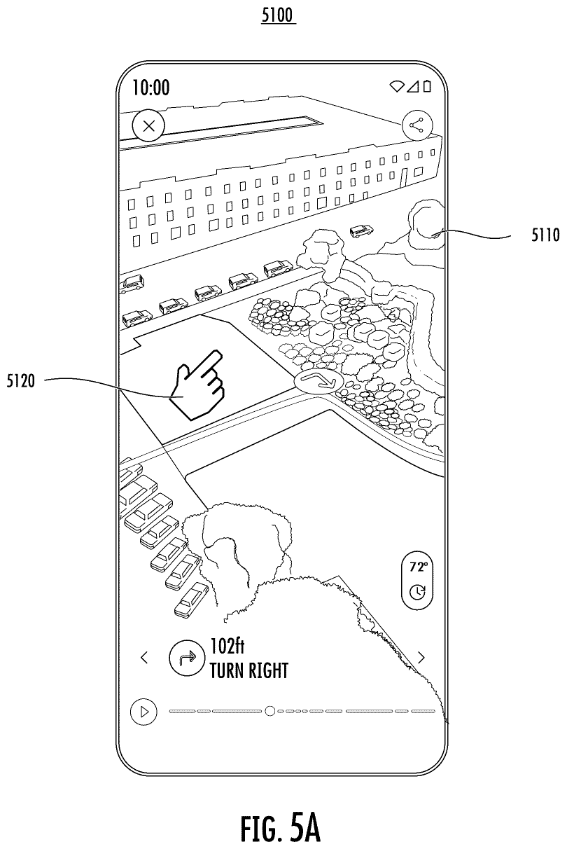

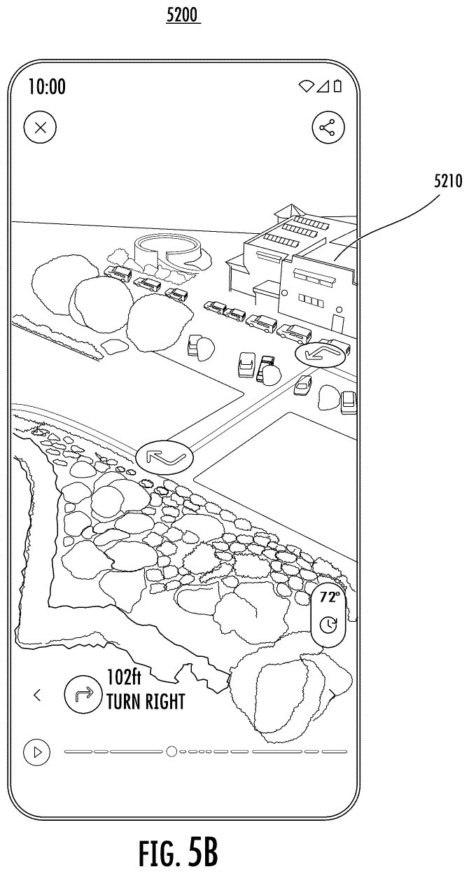

As another example, FIGS. 5A-5B are further example user interfaces depicting an example interactive three-dimensional scene of a location, according to one or more example embodiments of the disclosure. In FIG. 5A, a first user interface 5100 includes content (e.g., an interactive 3D scene) which is rendered by the first computing system 3100, including first content 5110 which shows a 3D scene with a depiction of directions to a particular geographic location at a particular part of a route where a user can provide an input 5120 (e.g., touch input) for changing a view of the interactive 3D scene. For example, a user can provide an input to change an orientation of the view to obtain information regarding the geographic location from a different perspective, thereby changing a view of the 3D scene. In response to receiving the input, rendering operations can be maintained at the first computing system 3100 to perform one or more subsequent rendering operations. For example, in FIG. 5B a second user interface 5200 includes content (e.g., an interactive 3D scene) which has been rendered by the first computing system 3100, including second content 5210 which shows a subsequent 3D scene with a depiction of the directions to the particular geographic location at the particular part of the route but from a different perspective. According to previous methods, if a user provides an input to rotate or adjust a perspective of a view of a 3D scene, the information associated with the input must be transmitted to the second computing system 3300 and the second computing system 3300 processes the information and then renders the subsequent 3D scene according to the information associated with the input. However, according to the examples of the disclosure, computing resources (e.g., network resources) can be conserved by avoiding the need to transmit the information associated with the input as the first computing system 3100 is capable of rendering the 3D scene according to the user input changing the view of the 3D scene (e.g., an input to the 3D scene rather than to a particular user interface element).

FIG. 2D illustrates an example method 2400 for determining whether rendering criteria are satisfied for selecting the first computing system 3100 and/or the second computing system 3300 to render visual elements associated with an interactive 3D scene, according to examples of the disclosure. In some implementations, the one or more rendering criteria can include whether a size of information associated with the interactive 3D scene to be rendered is greater than a threshold level. For example, at operation 2410 the first computing system 3100 (or in some implementations the second computing system 3300) can determine whether the size of the information associated with the interactive 3D scene to be rendered is greater than the threshold level. For example, the second computing system 3300 (e.g., the second data payload/network condition determiner 3328) can be configured to determine the size of the information associated with the interactive 3D scene to be rendered and can transmit the information indicating the size of the information associated with the interactive 3D scene to the first computing system 3100 (e.g., to the first data payload/network condition determiner 3128). At operation 2420, in response to determining the size of the information associated with the interactive 3D scene to be rendered is greater than the threshold level, the method 2400 can include selecting the second computing system 3300 to initially perform the one or more rendering operations with respect to the plurality of visual elements associated with the interactive 3D scene of the location while the information associated with the interactive 3D scene (e.g., information associated with the 3D scene 3160) is transmitted from the second computing system 3300 to the first computing system 3100. For example, a large data payload (e.g., the information associated with the interactive 3D scene to be rendered) can be transferred to the first computing system 3100 in the background while the second computing system 3300 initially renders the interactive 3D scene, thus minimizing delay experienced by the user and enabling a smooth transition from the second computing system 3300 performing rendering operations to the first computing system 3100 performing rendering operations. At operation 2430 the method 2400 can include, in response to the completion of the information associated with the interactive 3D scene being transmitted to the first computing system 3100, switching to the first computing system 3100 to perform any remaining rendering operations among the one or more rendering operations with respect to the plurality of visual elements associated with the interactive 3D scene of the location. At operation 2440, in response to determining the size of the information associated with the interactive 3D scene to be rendered is not greater than the threshold level, the method 2400 can include selecting the first computing system 3100 to perform the one or more rendering operations with respect to the plurality of visual elements associated with the interactive 3D scene of the location.

FIG. 2E illustrates an example method 2500 for determining whether rendering criteria are satisfied for selecting the first computing system 3100 and/or the second computing system 3300 to render visual elements associated with an interactive 3D scene, according to examples of the disclosure. In some implementations, the one or more rendering criteria can include whether the first computing system 3100 has sufficient resources (e.g., computing resources such as processing power, a 3D graphics library, memory, etc.) for performing the one or more rendering operations. For example, at operation 2510 the first computing system 3100 (or in some implementations the second computing system 3300) can determine whether the first computing system 3100 has insufficient resources to perform the one or more rendering operations with respect to a plurality of visual elements associated with the interactive 3D scene of the location, to generate the plurality of rendered visual elements. For example, the second computing system 3300 (e.g., the second device capability determiner 3326) can receive information indicating whether the first computing system 3100 has sufficient or insufficient resources to perform the one or more rendering operations from the first computing system 3100 (e.g., from the first device capability determiner 3126). For example, the second computing system 3300 (e.g., the second device capability determiner 3326) can retrieve information indicating whether the first computing system 3100 has sufficient or insufficient resources to perform the one or more rendering operations from the device data store 350, external content 500, etc. At operation 2520, in response to determining the first computing system 3100 has insufficient resources to perform the one or more rendering operations, the method 2500 can include selecting the second computing system 3300 to perform the one or more rendering operations with respect to the plurality of visual elements associated with the interactive 3D scene of the location. At operation 2530, in response to determining the first computing system 3100 does not have insufficient resources (has sufficient resources) to perform the one or more rendering operations, the method 2500 can include selecting the first computing system 3100 to perform the one or more rendering operations with respect to the plurality of visual elements associated with the interactive 3D scene of the location.

For example, the sufficient resources can correspond to a processing power of the first computing system 3100, and the method 2500 can include determining whether the processing power of the first computing system 3100 meets certain processing power criteria at operation 2510. For example, the processing power criteria can correspond to a graphics processing unit that is capable of handling intensive graphics rendering for an interactive 3D scene with low latency such that rendering can be performed with a high frame rate and with sufficient resolution to be accurate and realistic, as well as useful and enjoyable for the end user. For example, the processing power criteria can correspond to a computing device (e.g., a smartphone, laptop, etc.) that has one or more processors (e.g., a graphics processing unit) that is capable of executing and providing immersive experiences via augmented reality applications, virtual reality applications, extended reality applications, etc. (e.g., via an augmented reality tool or extended reality tool such as ARCore).

For example, the sufficient resources can correspond to a 3D graphics library, and the method 2500 can include determining whether the first computing system 3100 includes the 3D graphics library at operation 2510. For example, the 3D graphics library can correspond to a collection of functions and tools that provide the functionality for rendering interactive 3D models (e.g., via rasterization or ray tracing techniques), handling textures (e.g., to add detail by adding textures onto 3D surfaces), lighting and shading (e.g., to define how light interacts with surfaces, including shadows, reflections, and materials), transformations (e.g., translating, rotating, and scaling 3D objects within the scene), and camera positioning (e.g., defining a perspective in the 3D scene).

FIG. 2F illustrates an example method 2600 for determining whether rendering criteria are satisfied for selecting the first computing system 3100 and/or the second computing system 3300 to render visual elements associated with an interactive 3D scene, according to examples of the disclosure. In some implementations, the one or more rendering criteria can include whether the second computing system 3300 has an available computing resource (e.g., an available graphics processing unit) for performing the one or more rendering operations. For example, at operation 2610 the first computing system 3100 (or in some implementations the second computing system 3300) can determine whether the second computing system 3300 has the available computing resource to perform the one or more rendering operations with respect to a plurality of visual elements associated with the interactive 3D scene of the location, to generate the plurality of rendered visual elements. For example, the second computing system 3300 can transmit information to the first computing system 3100 indicating whether the second computing system 3300 has the available computing resource to perform the one or more rendering operations. For example, the second computing system 3300 may include hundreds or thousands of GPUs, which may be occupied by other users. In such a case, the second computing system 3300 (e.g., the second device capability determiner 3326) may notify the first computing system 3100 (e.g., the first device capability determiner 3126) or transmit information to the first computing system 3100 indicating that the second computing system 3300 does not have an available computing resource. At operation 2620, in response to determining the second computing system 3300 has the particular computing resource available to perform the one or more rendering operations, the method 2600 can include selecting the second computing system 3300 to perform the one or more rendering operations with respect to the plurality of visual elements associated with the interactive 3D scene of the location. At operation 2630, in response to determining the second computing system 3300 does not have the particular computing resource available to perform the one or more rendering operations, the method 2600 can include selecting the first computing system 3100 to perform the one or more rendering operations with respect to the plurality of visual elements associated with the interactive 3D scene of the location.

In some implementations, in response to the computing resource (e.g., a GPU) subsequently becoming available after determining the second computing system 3300 does not have the computing resource available to perform the one or more rendering operations, the first computing system 3100 can be selected (or switched to) to perform any remaining rendering operations among the one or more rendering operations with respect to the plurality of visual elements associated with the interactive 3D scene of the location.

In some implementations, the first computing system 3100 or second computing system 3300 can place a reservation (e.g., with the second application 3320) for the computing resource in response to determining the second computing system 3300 does not have the computing resource available to perform the one or more rendering operations. For example, the second computing system 3300 can place the first computing system 3100 in a queue and notify the first computing system 3100 when the first computing system's 3100 turn comes up as the computing resource becomes available. For example, the second computing system 3300 can assign a particular time at which the first computing system 3100 can access the computing resource. In some implementations, in response to the computing resource subsequently becoming available according to the reservation, the second computing system 3300 can be switched to for performing any remaining rendering operations among the one or more rendering operations with respect to the plurality of visual elements associated with the interactive 3D scene of the location.

In some implementations, other rendering criteria can also be considered for determining whether the rendering criteria are satisfied for selecting the first computing system 3100 and/or the second computing system 3300 to render visual elements associated with an interactive 3D scene, according to examples of the disclosure. For example, the one or more rendering criteria can include whether a network connection condition associated with a network connecting the first computing system 3100 and the second computing system 3200 meets particular network criteria and whether a size of information associated with the interactive 3D scene to be rendered is greater than a threshold level. For example, the first computing system 3100 (or in some implementations the second computing system 3300) can determine (e.g., via the first data payload/network condition determiner 3128 or second data payload/network condition determiner 3328) whether the network connection condition associated with the network 400 connecting the first computing system 3100 and the second computing system 3200 meets particular network criteria and whether the size of information associated with the interactive 3D scene to be rendered is greater than the threshold level. In some implementations, in response to determining the network connection condition meets the particular network criteria or the size of the information associated with the interactive 3D scene to be rendered is less than the threshold level, the first computing system 3100 can be selected to perform the one or more rendering operations with respect to the plurality of visual elements associated with the interactive 3D scene of the location. In some implementations, in response to determining the network connection condition does not meet the particular network criteria and the size of the information associated with the interactive 3D scene to be rendered is greater than the threshold level, the second computing system 3300 can be selected to perform the one or more rendering operations while the information associated with the interactive 3D scene (e.g., information associated with the 3D scene 3160) is transmitted from the second computing system 3300 to the first computing system 3100. In some implementations, in response to completion of the information associated with the interactive 3D scene being transmitted to the first computing system, the first computing system 3100 can be switched to for performing any remaining rendering operations among the one or more rendering operations with respect to the plurality of visual elements associated with the interactive 3D scene of the location.

For example, the particular network criteria can correspond to a particular strength or quality of the network connection (e.g., a network signal strength threshold). For example, the first data payload/network condition determiner 3128 or second data payload/network condition determiner 3328 may be configured to determine the RSSI or RSRP value based on a difference between a signal transmission power and losses (e.g., path loss) which occur during propagation of a signal between the first computing system 3100 and second computing system 3300. In some implementations, the first data payload/network condition determiner 3128 or second data payload/network condition determiner 3328 may be configured to measure or calculate a signal-to-noise ratio (SNR) as the signal strength. For example, the SNR value corresponds to a measure of the ratio between the received signal power and the background noise power. In some implementations, other metrics for defining network criteria which can be utilized for determining network conditions can include an available bandwidth, network utilization, quality of service metrics, throughput rate, etc. In some implementations, the network condition or network criteria can include whether a particular type of network is being used for communications between the first computing system 3100 and second computing system 3300. For example, if the first computing system 3100 and second computing system 3300 are connected over Wi-Fi, then the network connection condition may be determined to meet the particular network criteria.

In some implementations, the interactive 3D scene can be displayed in a user interface and the user interface can also include one or more user interface elements (e.g., as described in the examples of FIGS. 4A-5B). In some implementations, one or more of the user interface elements can be selectable for requesting or selecting a fidelity level for displaying the interactive 3D scene of the location to be displayed. In some implementations, the one or more rendering criteria can include whether the fidelity level selected via the at least one selectable user interface element is greater than a threshold fidelity level. For example, in response to the fidelity level selected via the at least one selectable user interface element being greater than the threshold fidelity level, the second computing system 3300 can be selected to perform the one or more rendering operations with respect to the plurality of visual elements associated with the interactive 3D scene of the location. For example, in response to the fidelity level selected via the at least one selectable user interface element being less than the threshold fidelity level, the first computing system 3100 can be selected to perform the one or more rendering operations with respect to the plurality of visual elements associated with the interactive 3D scene of the location.

In some implementations, the one or more rendering criteria can include whether a particular frame associated with the interactive 3D scene includes at least some content having a complexity level greater than a threshold complexity level. For example, the complexity level can be associated with a degree or magnitude of motion associated with the interactive 3D scene, a change in visual content (e.g., a change in color, a change in objects, etc.) associated with the interactive 3D scene (e.g., between adjacent frames of a video composed of a plurality of or a sequence of frames of an interactive 3D scene of a location). For example, the complexity level can be associated with the number of objects appearing in the interactive 3D scene.

For example, the first computing system 3100 and/or the second computing system 3300 can be configured to determine a complexity level of a frame. In some implementations, in response to determining the particular frame associated with the interactive 3D scene includes at least some content having the complexity level greater than the threshold complexity level, the first computing system 3100 can be selected to perform the one or more rendering operations for a first portion of the particular frame and the second computing system 3300 can be selected to perform the one or more rendering operations for a second portion of the particular frame. For example, the content in the first portion of the particular frame does not have the complexity level greater than the threshold complexity level and the content in the second portion of the particular frame has the complexity level greater than the threshold complexity level. Accordingly, an individual rendered frame associated with the interactive three-dimensional scene can be a composite of local and cloud rendered data where more expensive (more complex) overlays that require more data can be rendered at the second computing system 3300 (e.g., the server computing system 300) and less expensive (less complex) content can be rendered at the first computing system 3100 (e.g., the computing device 100).

As described herein, the first computing system 3100 and/or the second computing system 3300 can render visual elements associated with an interactive 3D scene of a location. In some implementations, the first computing system 3100 can obtain information associated with the interactive 3D scene of the location (e.g., image data, video data, etc.) from the second computing system 3300 (e.g., information associated with 3D scene 3160), and can store such information, for example, at first 3D scene content 3124. The first computing system 3100 can subsequently render the visual elements via first renderer 3122. The one or more rendering operations can include various operations involving a rendering or graphics pipeline, based on underlying data associated with an image or video frame associated with the interactive 3D scene of the location. The first renderer 3122 may comprise one or more GPUs, for example. The first renderer 3122 may be configured to assign each visual element (e.g., each pixel) particular color values (e.g., RGB values) and, optionally, an alpha value for transparency to determine the visual element's appearance on a display device. The rendering or graphics pipeline can process these values, and perform operations including gamma correction, vertex processing, rasterization or ray casting, shading, and blending, and can map each visual element to a physical location on the display device, where the display device is configured to light the visual element. The first renderer 3122 may be configured to perform the rendering operations at a particular speed (e.g., 24 frames per second, 30 frames per second, 60 frames per second, etc.) to ensure smooth performance and playback for viewing by a user.

In some implementations, the second computing system 3300 can store information associated with the interactive 3D scene of the location (e.g., image data, video data, etc.), for example, at second 3D scene content 3324 and can transmit such information to the first computing system 3100. The second computing system 3300 can be configured to render visual elements via second renderer 3322. The one or more rendering operations can include various operations involving a rendering or graphics pipeline, based on underlying data associated with an image or video frame associated with the interactive 3D scene of the location. The second renderer 3322 may comprise one or more GPUs, for example. The second renderer 3322 may have a higher processing power than the first renderer 3122, for example. The second renderer 3322 may be configured to assign each visual element (e.g., each pixel) particular color values (e.g., RGB values) and, optionally, an alpha value for transparency to determine the visual element's appearance on a display device. The rendering or graphics pipeline can process these values, and perform operations including gamma correction, vertex processing, rasterization or ray casting, shading, and blending, and can map each visual element to a physical location on a display device which is to display the image or video, where the display device is configured to light the visual element. The second renderer 3322 may be configured to perform the rendering operations at a particular speed (e.g., 24 frames per second, 30 frames per second, 60 frames per second, etc.) to ensure smooth performance and playback for viewing by a user.

Referring back to FIG. 2A, at operation 2120 the method 2100 includes providing, for presentation via a display device of the first computing system, the interactive 3D scene of the location, based on the plurality of rendered visual elements. For example, as described herein according to whether certain rendering criteria is satisfied, the first computing system 3100 and/or the second computing system 3300 can render the visual elements associated with the interactive 3D scene of the location. In some implementations, the first computing system 3100 may be configured to perform the rendering operations to generate the rendered visual elements and output content 3130. In some implementations, the content 3130 can include a user interface which includes the interactive 3D scene (e.g., comprising an image or video) and one or more user interface elements. In some implementations, the content 3130 can include a video (e.g., an immersive view video) of a location. However, the disclosure is not limited to content associated with navigation and other content genres can be output. In some implementations, the second computing system 3300 may be configured to perform the rendering operations to generate the rendered visual elements and transmit (e.g., stream) the rendered visual elements to the first computing system 3100 (e.g., rendered visual elements 3170 in FIG. 3). The first computing system 3100 can then output content 3130 based on the rendered visual elements 3170. In some implementations, the rendered visual elements received from the second computing system 3300 may be associated with and include a user interface which includes the interactive 3D scene (e.g., comprising an image or video) and one or more user interface elements. In some implementations, the rendered visual elements received from the second computing system 3300 may be associated with and include a video (e.g., an immersive view video) of a location which is comprised of pixels streamed from the second computing system 3300 to the first computing system 3100. However, the disclosure is not limited to content or interactive 3D scenes associated with navigation and other content genres can be generated (rendered) and output.

FIG. 2B illustrates an example in which the second computing system 3300 can perform operations which efficiently determine whether the first computing system 3100 and/or the second computing system 3300 perform one or more rendering operations with respect to an interactive 3D scene. Referring to FIG. 2B, at operation 2210 the method 2200 includes a second computing system determining whether one or more rendering criteria related to performing one or more rendering operations with respect to a plurality of visual elements associated with an interactive three-dimensional (3D) scene of a location, are satisfied. As described herein, the second computing system 3300 may be embodied as server computing system 300, for example. In the environment 3000 of FIG. 3, in some implementations the first computing system 3100 (which can correspond to computing device 100) may be configured to receive a user input 3110 to execute a first application 3120 (e.g., a navigation application) that is configured to display the interactive 3D scene (e.g., a video comprising a plurality of frames which include a sequence of three-dimensional scenes which can, in some implementations, provide an immersive view of a location or a fly-through experience of a location). As an example, a user may want to know more about a geographic location or point-of-interest and the user provides one or more inputs to execute the first application 3120 to obtain information about the geographic location or point-of-interest. The input may be a text input or voice input, for example (e.g., “tell me what traffic is like downtown at 11 am,” “give me directions to the wharf,” etc.). In some implementations, the first application 3120 may be configured to interact with or execute the second application 3320 remotely to obtain information responsive to the input received from the user (e.g., the directions, an image or video of the location, etc.) for output to the user of the first computing system 3100.

According to examples of the disclosure, according to whether certain rendering criteria are satisfied, the content to be output to the user including the interactive 3D scene of the location, can be rendered (e.g., in real-time) and output at the first computing system 3100 (e.g., in real-time) and/or the content to be output including the interactive 3D scene of the location can be requested from the second computing system 3300 and the second computing system 3300 can render the content (e.g., in real-time) and stream rendered visual elements (e.g., pixels) to the first computing system 3100 (e.g., in real-time). In some implementations, the second computing system 3300 (which can correspond to the server computing system 300) has a higher processing power than the first computing system 3100.

At operation 2220 the method 2200 includes, when the one or more rendering criteria are satisfied, the first computing system 3100 can be selected (e.g., by the second computing system 3300) to perform one or more rendering operations associated with the interactive 3D scene of the location. At operation 2230 the method 2200 includes the second computing system 3300 transmitting information associated with the 3D scene (e.g., information associated with visual elements forming an image, frame, video, etc.) to the first computing system 3100. The first computing system 3100 can be configured to generate a plurality of rendered visual elements based on the information received from the second computing system 3300 as described herein.

At operation 2240 the method 2200 includes, when the one or more rendering criteria are not satisfied, the second computing system 3300 can be selected (e.g., by the second computing system 3300) to perform the one or more rendering operations. For example, at operation 2250 the method 2200 includes the second computing system 3300 transmitting (e.g., streaming) the rendered visual elements to the first computing system 3100. For example, the visual elements can correspond to pixels, sub-pixels, voxels, or other units of visual representation that compose or form an image (e.g., a 3D scene), frame, video, etc.

Referring to FIG. 3, the second computing system 3300 (e.g., second application 3320) may be configured to determine whether one or more rendering criteria related to performing one or more rendering operations with respect to a plurality of visual elements associated with an interactive three-dimensional (3D) scene of a location, are satisfied. Example rendering criteria can correspond to or be similar to the one or more rendering criteria already described herein with respect to FIGS. 2C through 2F.

For example, in some implementations, when the first computing system 3100 displays a user interface including the interactive 3D scene of the location and at least one selectable user interface element configured to control a view of the interactive 3D scene of the location, the one or more rendering criteria can include whether the at least one selectable user interface element is selected, and in response to receiving an indication of a selection of the at least one selectable user interface element, the second computing system 3300 can be configured to select the second computing system 3300 to perform one or more subsequent rendering operations.

In some implementations, the one or more rendering criteria includes whether a size of information associated with the interactive 3D scene to be rendered is greater than a threshold level. In response to the size of the information associated with the interactive 3D scene to be rendered being determined (e.g., by the second computing system 3300) to be greater than the threshold level, the second computing system 3300 can be selected to initially perform the one or more rendering operations with respect to the plurality of visual elements associated with the interactive 3D scene of the location while the information associated with the interactive 3D scene is transmitted from the second computing system 3300 to the first computing system 3100. In response to completion of the information associated with the interactive 3D scene being transmitted to the first computing system 3100, the first computing system 3100 can be switched to for performing any remaining rendering operations among the one or more rendering operations with respect to the plurality of visual elements associated with the interactive 3D scene of the location.

In some implementations, the one or more rendering criteria includes whether a processing power of the first computing system 3100 meets processing power criteria. For example, in response to the processing power of the first computing system 3100 being determined (e.g., by the second computing system 3300) to meet the processing power criteria, the first computing system 3100 may be selected to perform the one or more rendering operations, and in response to the processing power of the first computing system 3100 not meeting the processing power criteria, the second computing system 3300 can be selected to perform the one or more rendering operations.

In some implementations, the one or more rendering criteria includes whether the first computing system 3100 stores a 3D graphics library. For example, in response to the first computing system 3100 being determined (e.g., by the second computing system 3300) to store the 3D graphics library, the first computing system 3100 can be selected to perform the one or more rendering operations, and in response to the first computing system 3100 being determined (e.g., by the second computing system 3300) to not store the 3D graphics library, the second computing system 3300 can be selected to perform the one or more rendering operations.

In some implementations, the one or more rendering criteria includes whether the second computing system 3300 has a particular computing resource available to perform the one or more rendering operations. For example, in response to the second computing system 3300 being determined (e.g., by the second computing system 3300) to not have the particular computing resource available to perform the one or more rendering operations, the first computing system 3100 can be selected to perform the one or more rendering operations, and in response to the second computing system 3300 being determined (e.g., by the second computing system 3300) to have the particular computing resource available to perform the one or more rendering operations, the second computing system 3300 can be selected to perform the one or more rendering operations. In some implementations, in response to the particular computing resource subsequently becoming available after determining the second computing system 3300 does not have the particular computing resource available to perform the one or more rendering operations, the second computing system 3300 can be switched to for performing any remaining rendering operations among the one or more rendering operations with respect to the plurality of visual elements associated with the interactive 3D scene of the location.

In some implementations, the second computing system 3300 can place a reservation for the particular computing resource in response to determining the second computing system 3300 does not have the particular computing resource available to perform the one or more rendering operations. For example, in response to the particular computing resource subsequently becoming available according to the reservation, the second computing system 3300 can be switched to for performing any remaining rendering operations among the one or more rendering operations with respect to the plurality of visual elements associated with the interactive 3D scene of the location.

In some implementations, the one or more rendering criteria includes whether a network connection condition associated with a network connecting the first computing system 3100 and the second computing system 3300 meets particular network criteria and whether a size of information associated with the interactive 3D scene to be rendered is greater than a threshold level. For example, in response to the second computing system 3300 determining the network connection condition meets the particular network criteria or the size of the information associated with the interactive 3D scene to be rendered is less than the threshold level, the second computing system 3300 can select the first computing system 3100 to perform the one or more rendering operations, and in response to the second computing system 3300 determining the network connection condition does not meet the particular network criteria and the size of the information associated with the interactive 3D scene to be rendered is greater than the threshold level, the second computing system 3300 can select the second computing system 3300 to initially perform the one or more rendering operations while the information associated with the interactive 3D scene is transmitted from the second computing system 3300 to the first computing system 3100. In some implementations, in response to completion of the information associated with the interactive 3D scene being transmitted to the first computing system 3100, the second computing system 3300 can be switched to for performing any remaining rendering operations among the one or more rendering operations.

In some implementations, the interactive 3D scene can be displayed by a display device of the first computing system 3100 in a user interface and the user interface can also include one or more user interface elements (e.g., as described in the examples of FIGS. 4A-5B). In some implementations, one or more of the user interface elements can be selectable for requesting or selecting a fidelity level for displaying the interactive 3D scene of the location to be displayed.

In some implementations, the one or more rendering criteria can include whether the fidelity level selected via the at least one selectable user interface element is greater than a threshold fidelity level. For example, in response to the second computing system 3300 receiving an indication that the fidelity level selected via the at least one selectable user interface element is greater than the threshold fidelity level, the second computing system 3300 can be selected by the second computing system 3300 to perform the one or more rendering operations with respect to the plurality of visual elements associated with the interactive 3D scene of the location. For example, in response to the second computing system 3300 receiving an indication that the fidelity level selected via the at least one selectable user interface element is less than the threshold fidelity level, the first computing system 3100 can be selected by the second computing system 3300 to perform the one or more rendering operations with respect to the plurality of visual elements associated with the interactive 3D scene of the location.

In some implementations, the one or more rendering criteria includes whether a particular frame associated with the interactive 3D scene includes at least some content having a complexity level greater than a threshold complexity level. For example, in response to the second computing system 3300 determining the particular frame associated with the interactive 3D scene includes at least some content having the complexity level greater than the threshold complexity level, the second computing system 3300 can select the second computing system 3300 to perform the one or more rendering operations for a first portion of the particular frame and can select the first computing system 3100 to perform the one or more rendering operations for a second portion of the particular frame. For example, the content in the first portion of the particular frame does not have the complexity level greater than the threshold complexity level and the content in the second portion of the particular frame has the complexity level greater than the threshold complexity level. For example, the complexity level can be associated with a degree or magnitude of motion associated with the interactive 3D scene, a change in visual content (e.g., a change in color, a change in objects, etc.) associated with the interactive 3D scene (e.g., between adjacent frames of a video composed of a plurality of or a sequence of frames of an interactive 3D scene of a location). For example, the complexity level can be associated with the number of objects appearing in the interactive 3D scene.

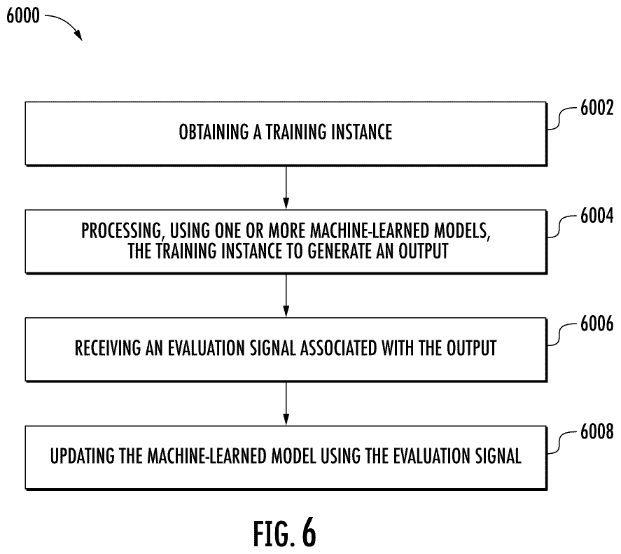

FIG. 6 depicts a flowchart of a method 6000 for training one or more machine-learned models according to aspects of the disclosure. For instance, an example machine-learned model can include one or more of a LLM, a generative machine-learned model, etc. For example, the one or more machine-learned models may be configured to generate some or all of the content for the interactive 3D scene (e.g., interactive 3D video comprising a plurality of frames corresponding to a plurality or sequence of interactive 3D scenes) as described herein.

FIG. 6 is a flow chart diagram illustrating an example method for training a machine-learned model according to example implementations of aspects of the disclosure. One or more portion(s) of example method 6000 can be implemented by a computing system that includes one or more computing devices such as, for example, computing systems described with reference to the other drawings. Each respective portion of example method 6000 can be performed by any (or any combination) of one or more computing devices. Moreover, one or more portion(s) of example method 6000 can be implemented on the hardware components of the device(s) described herein, for example, to train one or more systems or models. FIG. 6 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the disclosure. FIG. 6 is described with reference to elements/terms described with respect to other systems and drawings for exemplary illustrated purposes and is not meant to be limiting. One or more portions of example method 6000 can be performed additionally, or alternatively, by other systems.

At 6002, example method 6000 can include obtaining a training instance. A set of training data can include a plurality of training instances divided between multiple datasets (e.g., a training dataset, a validation dataset, or testing dataset). A training instance can be labeled or unlabeled. Although referred to in example method 6000 as a “training” instance, it is to be understood that runtime inferences can form training instances when a model is trained using an evaluation of the model's performance on that runtime instance (e.g., online training/learning). Example data types for the training instance and various tasks associated therewith are described throughout the disclosure.

At 6004, example method 6000 can include processing, using one or more machine-learned models, the training instance to generate an output. The output can be directly obtained from the one or more machine-learned models or can be a downstream result of a chain of processing operations that includes an output of the one or more machine-learned models.

At 6006, example method 6000 can include receiving an evaluation signal associated with the output. The evaluation signal can be obtained using a loss function. Various determinations of loss can be used, such as mean squared error, likelihood loss, cross entropy loss, hinge loss, contrastive loss, or various other loss functions. The evaluation signal can be computed using known ground-truth labels (e.g., supervised learning), predicted or estimated labels (e.g., semi-or self-supervised learning), or without labels (e.g., unsupervised learning).

The evaluation signal can be a reward (e.g., for reinforcement learning). The reward can be computed using a machine-learned reward model configured to generate rewards based on output(s) received. The reward can be computed using feedback data describing human feedback on the output(s).

At 6008, example method 6000 can include updating the machine-learned model using the evaluation signal. For example, values for parameters of the machine-learned model(s) can be learned, in some embodiments, using various training or learning techniques, such as, for example, backwards propagation. For example, the evaluation signal can be backpropagated from the output (or another source of the evaluation signal) through the machine-learned model(s) to update one or more parameters of the model(s) (e.g., based on a gradient of the evaluation signal with respect to the parameter value(s)). For example, system(s) containing one or more machine-learned models can be trained in an end-to-end manner. Gradient descent techniques can be used to iteratively update the parameters over a number of training iterations. In some implementations, performing backwards propagation of errors can include performing truncated backpropagation through time. Example method 6000 can include implementing a number of generalization techniques (e.g., weight decays, dropouts, etc.) to improve the generalization capability of the models being trained.

In some implementations, example method 6000 can be implemented for training a machine-learned model from an initialized state to a fully trained state (e.g., when the model exhibits a desired performance profile, such as based on accuracy, precision, recall, etc.).

In some implementations, example method 6000 can be implemented for particular stages of a training procedure. For instance, in some implementations, example method 6000 can be implemented for pre-training a machine-learned model. Pre-training can include, for instance, large-scale training over potentially noisy data to achieve a broad base of performance levels across a variety of tasks/data types. In some implementations, example method 6000 can be implemented for fine-tuning a machine-learned model. Fine-tuning can include, for instance, smaller-scale training on higher-quality (e.g., labeled, curated, etc.) data. Fine-tuning can affect all or a portion of the parameters of a machine-learned model. For example, various portions of the machine-learned model can be “frozen” for certain training stages. For example, parameters associated with an embedding space can be “frozen” during fine-tuning (e.g., to retain information learned from a broader domain(s) than present in the fine-tuning dataset(s)). An example fine-tuning approach includes reinforcement learning. Reinforcement learning can be based on user feedback on model performance during use.

### Example Machine-Learned Models

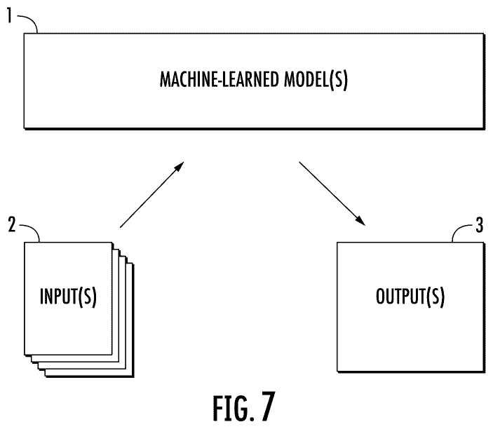

FIG. 7 is a block diagram of an example processing flow for using machine-learned model(s) 1 to process input(s) 2 to generate output(s) 3.

Machine-learned model(s) 1 can be or include one or multiple machine-learned models or model components. Example machine-learned models can include neural networks (e.g., deep neural networks). Example machine-learned models can include non-linear models or linear models. Example machine-learned models can use other architectures in lieu of or in addition to neural networks. Example machine-learned models can include decision tree based models, support vector machines, hidden Markov models, Bayesian networks, linear regression models, k-means clustering models, etc.

Example neural networks can include feed-forward neural networks, recurrent neural networks (RNNs), including long short-term memory (LSTM) based recurrent neural networks, convolutional neural networks (CNNs), diffusion models, generative-adversarial networks, or other forms of neural networks. Example neural networks can be deep neural networks. Some example machine-learned models can leverage an attention mechanism such as self-attention. For example, some example machine-learned models can include multi-headed self-attention models.

Machine-learned model(s) 1 can include a single or multiple instances of the same model configured to operate on data from input(s) 2. Machine-learned model(s) 1 can include an ensemble of different models that can cooperatively interact to process data from input(s) 2. For example, machine-learned model(s) 1 can employ a mixture-of-experts structure. See, e.g., Zhou et al., Mixture-of-Experts with Expert Routing Routing, ARXIV:2202.09368v2 (Oct. 14, 2022).

Input(s) 2 can generally include or otherwise represent various types of data. Input(s) 2 can include one type or many different types of data. Output(s) 3 can be data of the same type(s) or of different types of data as compared to input(s) 2. Output(s) 3 can include one type or many different types of data.

Example data types for input(s) 2 or output(s) 3 include natural language text data, software code data (e.g., source code, object code, machine code, or any other form of computer-readable instructions or programming languages), machine code data (e.g., binary code, assembly code, or other forms of machine-readable instructions that can be executed directly by a computer's central processing unit), assembly code data (e.g., low-level programming languages that use symbolic representations of machine code instructions to program a processing unit), genetic data or other chemical or biochemical data, image data, audio data, audiovisual data, haptic data, biometric data, medical data, financial data, statistical data, geographical data, astronomical data, historical data, sensor data generally (e.g., digital or analog values, such as voltage or other absolute or relative level measurement values from a real or artificial input, such as from an audio sensor, light sensor, displacement sensor, etc.), and the like. Data can be raw or processed and can be in any format or schema.

In multimodal inputs 2 or outputs 3, example combinations of data types include image data and audio data, image data and natural language data, natural language data and software code data, image data and biometric data, sensor data and medical data, etc. It is to be understood that any combination of data types in an input 2 or an output 3 can be present.

An example input 2 can include one or multiple data types, such as the example data types noted above. An example output 3 can include one or multiple data types, such as the example data types noted above. The data type(s) of input 2 can be the same as or different from the data type(s) of output 3. It is to be understood that the example data types noted above are provided for illustrative purposes only. Data types contemplated within the scope of the disclosure are not limited to those examples noted above.

### Example Machine-Learned Sequence Processing Models

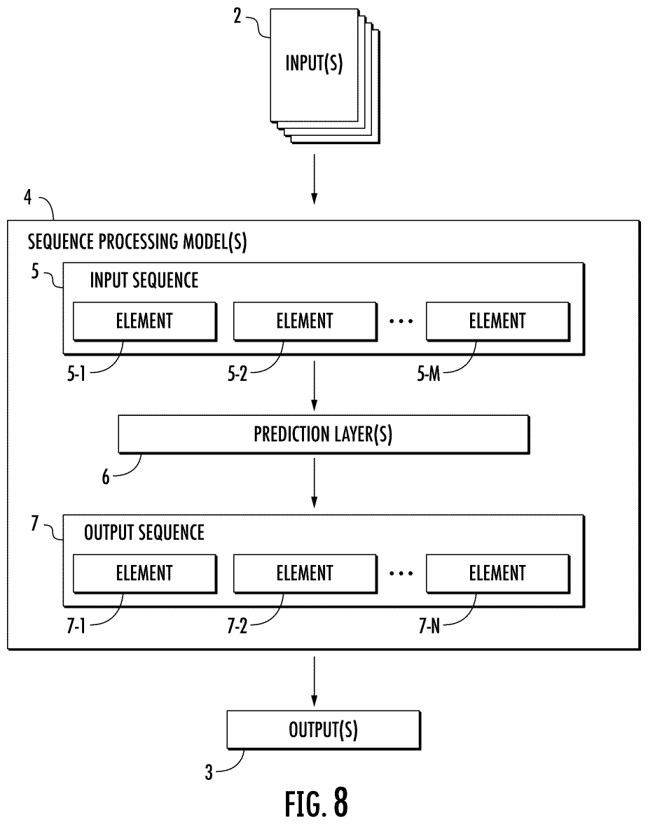

FIG. 8 is a block diagram of an example implementation of an example machine-learned model configured to process sequences of information. For instance, an example implementation of machine-learned model(s) 1 can include machine-learned sequence processing model(s) 4. An example system can pass input(s) 2 to sequence processing model(s) 4. Sequence processing model(s) 4 can include one or more machine-learned components. Sequence processing model(s) 4 can process the data from input(s) 2 to obtain an input sequence 5. Input sequence 5 can include one or more input elements 5-1, 5-2, . . . , 5-M, etc. obtained from input(s) 2. Sequence processing model 4 can process input sequence 5 using prediction layer(s) 6 to generate an output sequence 7. Output sequence 7 can include one or more output elements 7-1, 7-2, . . . , 7-N, etc. generated based on input sequence 5. The system can generate output(s) 3 based on output sequence 7.

Sequence processing model(s) 4 can include one or multiple machine-learned model components configured to ingest, generate, or otherwise reason over sequences of information. For example, some example sequence processing models in the text domain are referred to as “Large Language Models,” or LLMs. See, e.g., PaLM 2 Technical Report, GOOGLE, https://ai.google/static/documents/palm2techreport.pdf (n.d.). Other example sequence processing models can operate in other domains, such as image domains, see, e.g., Dosovitskiy et al., An Image is Worth 16×16 Words: Transformers for Image Recognition Scale Scale, ARXIV:2010.11929v2 (Jun. 3, 2021), audio domains, e.g. e.g., Agostinelli et al., MusicLM: Generating Music From Text, ARXIV:2301.11325v1 (Jan. 26, 2023), biochemical domains, see, e.g., Jumper et al., Highly accurate protein structure prediction with AlphaFold, 596 Nature 583 (Aug. 26, 2021), by way of example. Sequence processing model(s) 4 can process one or multiple types of data simultaneously. Sequence processing model(s) 4 can include relatively large models (e.g., more parameters, computationally expensive, etc.), relatively small models (e.g., fewer parameters, computationally lightweight, etc.), or both.

In general, sequence processing model(s) 4 can obtain input sequence 5 using data from input(s) 2. For instance, input sequence 5 can include a representation of data from input(s) 2 in a format understood by sequence processing model(s) 4. One or more machine-learned components of sequence processing model(s) 4 can ingest the data from input(s) 2, parse the data into pieces compatible with the processing architectures of sequence processing model(s) 4 (e.g., via “tokenization”), and project the pieces into an input space associated with prediction layer(s) 6 (e.g., via “embedding”).

Sequence processing model(s) 4 can ingest the data from input(s) 2 and parse the data into a sequence of elements to obtain input sequence 5. For example, a portion of input data from input(s) 2 can be broken down into pieces that collectively represent the content of the portion of the input data. The pieces can provide the elements of the sequence.

Elements 5-1, 5-2, . . . , 5-M can represent, in some cases, building blocks for capturing or expressing meaningful information in a particular data domain. For instance, the elements can describe “atomic units” across one or more domains. For example, for textual input source(s), the elements can correspond to groups of one or more words or sub-word components, such as sets of one or more characters.

For example, elements 5-1, 5-2, . . . , 5-M can represent tokens obtained using a tokenizer. For instance, a tokenizer can process a given portion of an input source and output a series of tokens (e.g., corresponding to input elements 5-1, 5-2, . . . , 5-M) that represent the portion of the input source. Various approaches to tokenization can be used. For instance, textual input source(s) can be tokenized using a byte-pair encoding (BPE) technique. See, e.g., Kudo et al., SentencePiece: A simple and language independent subword tokenizer and detokenizer for Neural Text Processing, PROCEEDINGS OF THE 2018 CONFERENCE ON EMPIRICAL METHODS IN NATURAL LANGUAGE PROCESSING (System Demonstrations), pages 66-71 (Oct. 31-Nov. 4, 2018), https://aclanthology.org/D18-2012.pdf. Image-based input source(s) can be tokenized by extracting and serializing patches from an image.

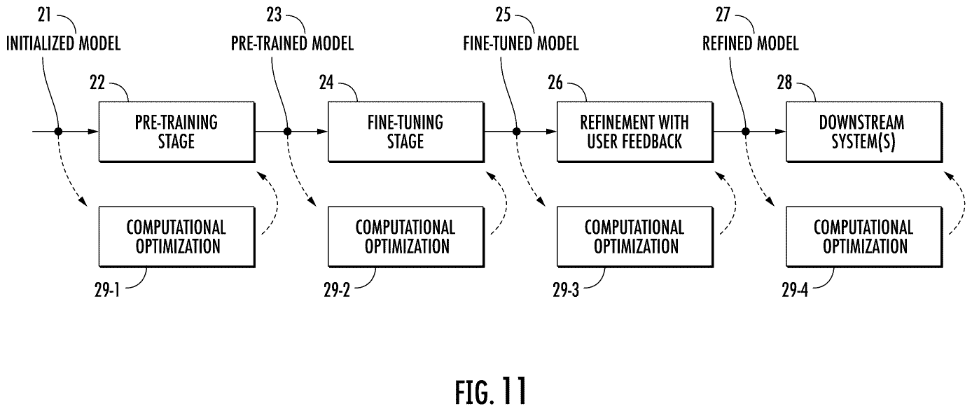

In general, arbitrary data types can be serialized and processed into input sequence 5. It is to be understood that element(s) 5-1, 5-2, . . . , 5-M depicted in FIG. 11 can be the tokens or can be the embedded representations thereof.

Prediction layer(s) 6 can predict one or more output elements 7-1, 7-2, . . . , 7-N based on the input elements. Prediction layer(s) 6 can include one or more machine-learned model architectures, such as one or more layers of learned parameters that manipulate and transform the input(s) to extract higher-order meaning from, and relationships between, input element(s) 5-1, 5-2, . . . , 5-M. In this manner, for instance, example prediction layer(s) 6 can predict new output element(s) in view of the context provided by input sequence 5.

Prediction layer(s) 6 can evaluate associations between portions of input sequence 5 and a particular output element. These associations can inform a prediction of the likelihood that a particular output follows the input context. For example, consider the textual snippet, “The carpenter's toolbox was small and heavy. It was full of ______.” Example prediction layer(s) 6 can identify that “It” refers back to “toolbox” by determining a relationship between the respective embeddings. Example prediction layer(s) 6 can also link “It” to the attributes of the toolbox, such as “small” and “heavy.” Based on these associations, prediction layer(s) 6 can, for instance, assign a higher probability to the word “nails” than to the word “sawdust.”

A transformer is an example architecture that can be used in prediction layer(s) 4. See, e.g., Vaswani et al., Attention Is All Need Need, ARXIV:1706.03762v7 (Aug. 2, 2023). A transformer is an example of a machine-learned model architecture that uses an attention mechanism to compute associations between items within a context window. The context window can include a sequence that contains input sequence 5 and potentially one or more output element(s) 7-1, 7-2, . . . , 7-N. A transformer block can include one or more attention layer(s) and one or more post-attention layer(s) (e.g., feedforward layer(s), such as a multi-layer perceptron).

Prediction layer(s) 6 can include other machine-learned model architectures in addition to or in lieu of transformer-based architectures. For example, recurrent neural networks (RNNs) and long short-term memory (LSTM) models can also be used, as well as convolutional neural networks (CNNs). In general, prediction layer(s) 6 can leverage various kinds of artificial neural networks that can understand or generate sequences of information.

Output sequence 7 can include or otherwise represent the same or different data types as input sequence 5. For instance, input sequence 5 can represent textual data, and output sequence 7 can represent textual data. Input sequence 5 can represent image, audio, or audiovisual data, and output sequence 7 can represent textual data (e.g., describing the image, audio, or audiovisual data). It is to be understood that prediction layer(s) 6, and any other interstitial model components of sequence processing model(s) 4, can be configured to receive a variety of data types in input sequence(s) 5 and output a variety of data types in output sequence(s) 7.

Output sequence 7 can have various relationships to input sequence 5. Output sequence 7 can be a continuation of input sequence 5. Output sequence 7 can be complementary to input sequence 5. Output sequence 7 can translate, transform, augment, or otherwise modify input sequence 5. Output sequence 7 can answer, evaluate, confirm, or otherwise respond to input sequence 5. Output sequence 7 can implement (or describe instructions for implementing) an instruction provided via input sequence 5.

Output sequence 7 can be generated autoregressively. For instance, for some applications, an output of one or more prediction layer(s) 6 can be passed through one or more output layers (e.g., softmax layer) to obtain a probability distribution over an output vocabulary (e.g., a textual or symbolic vocabulary) conditioned on a set of input elements in a context window. In this manner, for instance, output sequence 7 can be autoregressively generated by sampling a likely next output element, adding that element to the context window, and re-generating the probability distribution based on the updated context window, and sampling a likely next output element, and so forth.

Output sequence 7 can also be generated non-autoregressively. For instance, multiple output elements of output sequence 7 can be predicted together without explicit sequential conditioning on each other. See, e.g., Saharia et al., Non-Autoregressive Machine Translation with Latent Alignments, ARXIV:2004.07437v3 (Nov. 16, 2020).

Output sequence 7 can include one or multiple portions or elements. In an example content generation configuration, output sequence 7 can include multiple elements corresponding to multiple portions of a generated output sequence (e.g., a textual sentence, values of a discretized waveform, computer code, etc.). In an example classification configuration, output sequence 7 can include a single element associated with a classification output. For instance, an output “vocabulary” can include a set of classes into which an input sequence is to be classified. For instance, a vision transformer block can pass latent state information to a multilayer perceptron that outputs a likely class value associated with an input image.

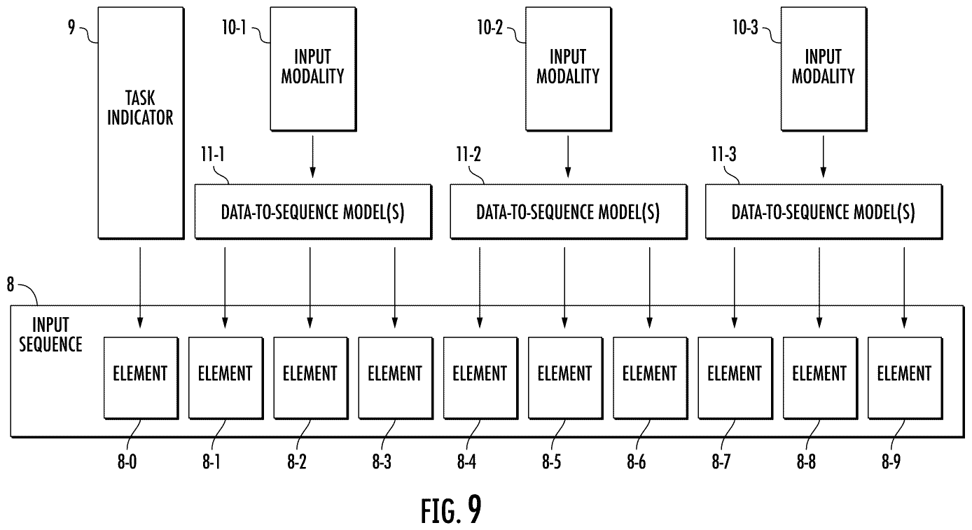

FIG. 9 is a block diagram of an example technique for populating an example input sequence 8. Input sequence 8 can include various functional elements that form part of the model infrastructure, such as an element 8-0 obtained from a task indicator 9 that signals to any model(s) that process input sequence 8 that a particular task is being performed (e.g., to help adapt a performance of the model(s) to that particular task). Input sequence 8 can include various data elements from different data modalities. For instance, an input modality 10-1 can include one modality of data. A data-to-sequence model 11-1 can process data from input modality 10-1 to project the data into a format compatible with input sequence 8 (e.g., one or more vectors dimensioned according to the dimensions of input sequence 8) to obtain elements 8-1, 8-2, 8-3. Another input modality 10-2 can include a different modality of data. A data-to-sequence model 11-2 can project data from input modality 10-2 into a format compatible with input sequence 8 to obtain elements 8-4, 8-5, 8-6. Another input modality 10-3 can include yet another different modality of data. A data-to-sequence model 11-3 can project data from input modality 10-3 into a format compatible with input sequence 8 to obtain elements 8-7, 8-8, 8-9.

Input sequence 8 can be the same as or different from input sequence 5. Input sequence 8 can be a multimodal input sequence that contains elements that represent data from different modalities using a common dimensional representation. For instance, an embedding space can have P dimensions. Input sequence 8 can be configured to contain a plurality of elements that have P dimensions. In this manner, for instance, example implementations can facilitate information extraction and reasoning across diverse data modalities by projecting data into elements in the same embedding space for comparison, combination, or other computations therebetween.

For example, elements 8-0, . . . , 8-9 can indicate particular locations within a multidimensional embedding space. Some elements can map to a set of discrete locations in the embedding space. For instance, elements that correspond to discrete members of a predetermined vocabulary of tokens can map to discrete locations in the embedding space that are associated with those tokens. Other elements can be continuously distributed across the embedding space. For instance, some data types can be broken down into continuously defined portions (e.g., image patches) that can be described using continuously distributed locations within the embedding space.

In some implementations, the expressive power of the embedding space may not be limited to meanings associated with any particular set of tokens or other building blocks. For example, a continuous embedding space can encode a spectrum of high-order information. An individual piece of information (e.g., a token) can map to a particular point in that space: for instance, a token for the word “dog” can be projected to an embedded value that points to a particular location in the embedding space associated with canine-related information. Similarly, an image patch of an image of a dog on grass can also be projected into the embedding space. In some implementations, the projection of the image of the dog can be similar to the projection of the word “dog” while also having similarity to a projection of the word “grass,” while potentially being different from both. In some implementations, the projection of the image patch may not exactly align with any single projection of a single word. In some implementations, the projection of the image patch can align with a combination of the projections of the words “dog” and “grass.” In this manner, for instance, a high-order embedding space can encode information that can be independent of data modalities in which the information is expressed.

Task indicator 9 can include a model or model component configured to identify a task being performed and inject, into input sequence 8, an input value represented by element 8-0 that signals which task is being performed. For instance, the input value can be provided as a data type associated with an input modality and projected along with that input modality (e.g., the input value can be a textual task label that is embedded along with other textual data in the input; the input value can be a pixel-based representation of a task that is embedded along with other image data in the input; etc.). The input value can be provided as a data type that differs from or is at least independent from other input(s). For instance, the input value represented by element 8-0 can be a learned within a continuous embedding space.

Input modalities 10-1, 10-2, and 10-3 can be associated with various different data types (e.g., as described above with respect to input(s) 2 and output(s) 3).

Data-to-sequence models 11-1, 11-2, and 11-3 can be the same or different from each other. Data-to-sequence models 11-1, 11-2, and 11-3 can be adapted to each respective input modality 10-1, 10-2, and 10-3. For example, a textual data-to-sequence model can subdivide a portion of input text and project the subdivisions into element(s) in input sequence 8 (e.g., elements 8-1, 8-2, 8-3, etc.). An image data-to-sequence model can subdivide an input image and project the subdivisions into element(s) in input sequence 8 (e.g., elements 8-4, 8-5, 8-6, etc.). An arbitrary datatype data-to-sequence model can subdivide an input of that arbitrary datatype and project the subdivisions into element(s) in input sequence 8 (e.g., elements 8-7, 8-8, 8-9, etc.).

Data-to-sequence models 11-1, 11-2, and 11-3 can form part of machine-learned sequence processing model(s) 4. Data-to-sequence models 11-1, 11-2, and 11-3 can be jointly trained with or trained independently from machine-learned sequence processing model(s) 4. Data-to-sequence models 11-1, 11-2, and 11-3 can be trained end-to-end with machine-learned sequence processing model(s) 4.

### Example Machine-Learned Model Development Platform

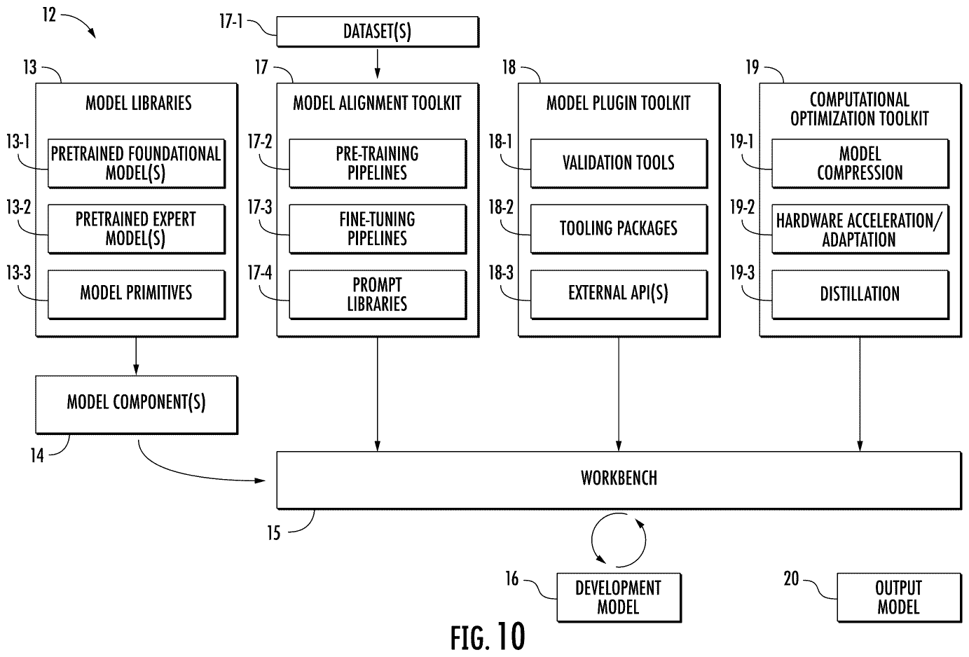

FIG. 10 is a block diagram of an example model development platform 12 that can facilitate creation, adaptation, and refinement of example machine-learned models (e.g., machine-learned model(s) 1, sequence processing model(s) 4, etc.). Model development platform 12 can provide a number of different toolkits that developer systems can employ in the development of new or adapted machine-learned models.

Model development platform 12 can provide one or more model libraries 13 containing building blocks for new models. Model libraries 13 can include one or more pre-trained foundational models 13-1, which can provide a backbone of processing power across various tasks. Model libraries 13 can include one or more pre-trained expert models 13-2, which can be focused on performance in particular domains of expertise. Model libraries 13 can include various model primitives 13-3, which can provide low-level architectures or components (optionally pre-trained), which can be assembled in various arrangements as desired.

Model development platform 12 can receive selections of various model components 14. Model development platform 12 can pass selected model components 14 to a workbench 15 that combines selected model components 14 into a development model 16.

Workbench 15 can facilitate further refinement and adaptation of development model 16 by leveraging a number of different toolkits integrated with model development platform 12. For example, workbench 15 can facilitate alignment of the development model 16 with a desired performance profile on various tasks using a model alignment toolkit 17.

Model alignment toolkit 17 can provide a number of tools for causing development model 16 to generate outputs aligned with desired behavioral characteristics. Alignment can include increasing an accuracy, precision, recall, etc. of model outputs. Alignment can include enforcing output styles, schema, or other preferential characteristics of model outputs. Alignment can be general or domain-specific. For instance, a pre-trained foundational model 13-1 can begin with an initial level of performance across multiple domains. Alignment of the pre-trained foundational model 13-1 can include improving a performance in a particular domain of information or tasks (e.g., even at the expense of performance in another domain of information or tasks).

Model alignment toolkit 17 can integrate one or more dataset(s) 17-1 for aligning development model 16. Curated dataset(s) 17-1 can include labeled or unlabeled training data. Dataset(s) 17-1 can be obtained from public domain datasets. Dataset(s) 17-1 can be obtained from private datasets associated with one or more developer system(s) for the alignment of bespoke machine-learned model(s) customized for private use-cases.

Pre-training pipelines 17-2 can include a machine-learned model training workflow configured to update development model 16 over large-scale, potentially noisy datasets. For example, pre-training can leverage unsupervised learning techniques (e.g., de-noising, etc.) to process large numbers of training instances to update model parameters from an initialized state and achieve a desired baseline performance. Pre-training pipelines 17-2 can leverage unlabeled datasets in dataset(s) 17-1 to perform pre-training. Workbench 15 can implement a pre-training pipeline 17-2 to pre-train development model 16.

Fine-tuning pipelines 17-3 can include a machine-learned model training workflow configured to refine the model parameters of development model 16 with higher-quality data. Fine-tuning pipelines 17-3 can update development model 16 by conducting supervised training with labeled dataset(s) in dataset(s) 17-1. Fine-tuning pipelines 17-3 can update development model 16 by conducting reinforcement learning using reward signals from user feedback signals. Workbench 15 can implement a fine-tuning pipeline 17-3 to fine-tune development model 16.

Prompt libraries 17-4 can include sets of inputs configured to induce behavior aligned with desired performance criteria. Prompt libraries 17-4 can include few-shot prompts (e.g., inputs providing examples of desired model outputs for prepending to a desired runtime query), chain-of-thought prompts (e.g., inputs providing step-by-step reasoning within the exemplars to facilitate thorough reasoning by the model), and the like.

Example prompts can be retrieved from an available repository of prompt libraries 17-4. Example prompts can be contributed by one or more developer systems using workbench 15.

In some implementations, pre-trained or fine-tuned models can achieve satisfactory performance without exemplars in the inputs. For instance, zero-shot prompts can include inputs that lack exemplars. Zero-shot prompts can be within a domain within a training dataset or outside of the training domain(s).

Prompt libraries 17-4 can include one or more prompt engineering tools. Prompt engineering tools can provide workflows for retrieving or learning optimized prompt values. Prompt engineering tools can facilitate directly learning prompt values (e.g., input element values) based one or more training iterations. Workbench 15 can implement prompt engineering tools in development model 16.

Prompt libraries 17-4 can include pipelines for prompt generation. For example, inputs can be generated using development model 16 itself or other machine-learned models. In this manner, for instance, a first model can process information about a task and output an input for a second model to process in order to perform a step of the task. The second model can be the same as or different from the first model. Workbench 15 can implement prompt generation pipelines in development model 16.

Prompt libraries 17-4 can include pipelines for context injection. For instance, a performance of development model 16 on a particular task can improve if provided with additional context for performing the task. Prompt libraries 17-4 can include software components configured to identify desired context, retrieve the context from an external source (e.g., a database, a sensor, etc.), and add the context to the input prompt. Workbench 15 can implement context injection pipelines in development model 16.

Although various training examples described herein with respect to model development platform 12 refer to “pre-training” and “fine-tuning,” it is to be understood that model alignment toolkit 17 can generally support a wide variety of training techniques adapted for training a wide variety of machine-learned models. Example training techniques can correspond to the example training method 6000 described above.

Model development platform 12 can include a model plugin toolkit 18. Model plugin toolkit 18 can include a variety of tools configured for augmenting the functionality of a machine-learned model by integrating the machine-learned model with other systems, devices, and software components. For instance, a machine-learned model can use tools to increase performance quality where appropriate. For instance, deterministic tasks can be offloaded to dedicated tools in lieu of probabilistically performing the task with an increased risk of error. For instance, instead of autoregressively predicting the solution to a system of equations, a machine-learned model can recognize a tool to call for obtaining the solution and pass the system of equations to the appropriate tool. The tool can be a traditional system of equations solver that can operate deterministically to resolve the system of equations. The output of the tool can be returned in response to the original query. In this manner, tool use can allow some example models to focus on the strengths of machine-learned models—e.g., understanding an intent in an unstructured request for a task—while augmenting the performance of the model by offloading certain tasks to a more focused tool for rote application of deterministic algorithms to a well-defined problem.

Model plugin toolkit 18 can include validation tools 18-1. Validation tools 18-1 can include tools that can parse and confirm output(s) of a machine-learned model. Validation tools 18-1 can include engineered heuristics that establish certain thresholds applied to model outputs. For example, validation tools 18-1 can ground the outputs of machine-learned models to structured data sources (e.g., to mitigate “hallucinations”).

Model plugin toolkit 18 can include tooling packages 18-2 for implementing one or more tools that can include scripts or other executable code that can be executed alongside development model 16. Tooling packages 18-2 can include one or more inputs configured to cause machine-learned model(s) to implement the tools (e.g., few-shot prompts that induce a model to output tool calls in the proper syntax, etc.). Tooling packages 18-2 can include, for instance, fine-tuning training data for training a model to use a tool.

Model plugin toolkit 18 can include interfaces for calling external application programming interfaces (APIs) 18-3. For instance, in addition to or in lieu of implementing tool calls or tool code directly with development model 16, development model 16 can be aligned to output instruction that initiate API calls to send or obtain data via external systems.

Model plugin toolkit 18 can integrate with prompt libraries 17-4 to build a catalog of available tools for use with development model 16. For instance, a model can receive, in an input, a catalog of available tools, and the model can generate an output that selects a tool from the available tools and initiates a tool call for using the tool.

Model development platform 12 can include a computational optimization toolkit 19 for optimizing a computational performance of development model 16. For instance, tools for model compression 19-1 can allow development model 16 to be reduced in size while maintaining a desired level of performance. For instance, model compression 19-1 can include quantization workflows, weight pruning and sparsification techniques, etc. Tools for hardware acceleration 19-2 can facilitate the configuration of the model storage and execution formats to operate optimally on different hardware resources. For instance, hardware acceleration 19-2 can include tools for optimally sharding models for distributed processing over multiple processing units for increased bandwidth, lower unified memory requirements, etc. Tools for distillation 19-3 can provide for the training of lighter-weight models based on the knowledge encoded in development model 16. For instance, development model 16 can be a highly performant, large machine-learned model optimized using model development platform 12. To obtain a lightweight model for running in resource-constrained environments, a smaller model can be a “student model” that learns to imitate development model 16 as a “teacher model.” In this manner, for instance, the investment in learning the parameters and configurations of development model 16 can be efficiently transferred to a smaller model for more efficient inference.

Workbench 15 can implement one, multiple, or none of the toolkits implemented in model development platform 12. Workbench 15 can output an output model 20 based on development model 16. Output model 20 can be a deployment version of development model 16. Output model 20 can be a development or training checkpoint of development model 16. Output model 20 can be a distilled, compressed, or otherwise optimized version of development model 16.

FIG. 11 is a block diagram of an example training flow for training a machine-learned development model 16. One or more portion(s) of the example training flow can be implemented by a computing system that includes one or more computing devices such as, for example, computing systems described with reference to the other drawings. Each respective portion of the example training flow can be performed by any (or any combination) of one or more computing devices. Moreover, one or more portion(s) of the example training flow can be implemented on the hardware components of the device(s) described herein, for example, to train one or more systems or models. FIG. 11 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the disclosure. FIG. 11 is described with reference to elements/terms described with respect to other systems and drawings for exemplary illustrated purposes and is not meant to be limiting. One or more portions of the example training flow can be performed additionally, or alternatively, by other systems.

Initially, development model 16 can persist in an initial state as an initialized model 21. Development model 16 can be initialized with weight values. Initial weight values can be random or based on an initialization schema. Initial weight values can be based on prior pre-training for the same or for a different model.

Initialized model 21 can undergo pre-training in a pre-training stage 22. Pre-training stage 22 can be implemented using one or more pre-training pipelines 17-2 over data from dataset(s) 17-1. Pre-training can be omitted, for example, if initialized model 21 is already pre-trained (e.g., development model 16 contains, is, or is based on a pre-trained foundational model or an expert model).

Pre-trained model 23 can then be a new version of development model 16, which can persist as development model 16 or as a new development model. Pre-trained model 23 can be the initial state if development model 16 was already pre-trained. Pre-trained model 23 can undergo fine-tuning in a fine-tuning stage 24. Fine-tuning stage 24 can be implemented using one or more fine-tuning pipelines 17-3 over data from dataset(s) 17-1. Fine-tuning can be omitted, for example, if a pre-trained model as satisfactory performance, if the model was already fine-tuned, or if other tuning approaches are preferred.

Fine-tuned model 29 can then be a new version of development model 16, which can persist as development model 16 or as a new development model. Fine-tuned model 29 can be the initial state if development model 16 was already fine-tuned. Fine-tuned model 29 can undergo refinement with user feedback 26. For instance, refinement with user feedback 26 can include reinforcement learning, optionally based on human feedback from human users of fine-tuned model 25. As reinforcement learning can be a form of fine-tuning, it is to be understood that fine-tuning stage 24 can subsume the stage for refining with user feedback 26. Refinement with user feedback 26 can produce a refined model 27. Refined model 27 can be output to downstream system(s) 28 for deployment or further development.

In some implementations, computational optimization operations can be applied before, during, or after each stage. For instance, initialized model 21 can undergo computational optimization 29-1 (e.g., using computational optimization toolkit 19) before pre-training stage 22. Pre-trained model 23 can undergo computational optimization 29-2 (e.g., using computational optimization toolkit 19) before fine-tuning stage 24. Fine-tuned model 25 can undergo computational optimization 29-3 (e.g., using computational optimization toolkit 19) before refinement with user feedback 26. Refined model 27 can undergo computational optimization 29-4 (e.g., using computational optimization toolkit 19) before output to downstream system(s) 28. Computational optimization(s) 29-1, . . . , 29-4 can all be the same, all be different, or include at least some different optimization techniques.

### Example Machine-Learned Model Inference System

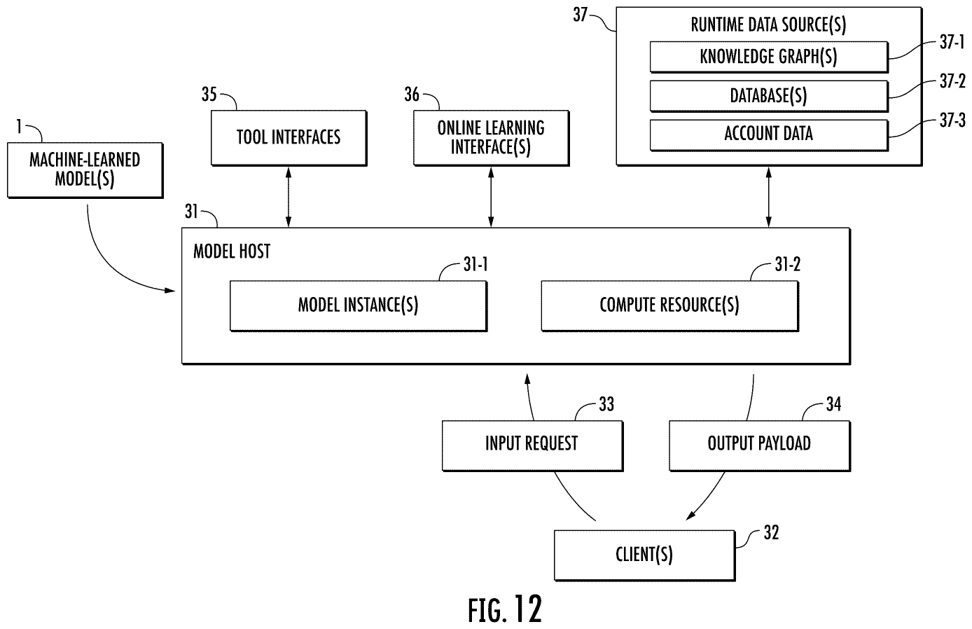

FIG. 12 is a block diagram of an inference system for operating one or more machine-learned model(s) 1 to perform inference (e.g., for training, for deployment, etc.). A model host 31 can receive machine-learned model(s) 1. Model host 31 can host one or more model instance(s) 31-1, which can be one or multiple instances of one or multiple models. Model host 31 can host model instance(s) 31-1 using available compute resources 31-2 associated with model host 31.

Model host 31 can perform inference on behalf of one or more client(s) 32. Client(s) 32 can transmit an input request 33 to model host 31. Using input request 33, model host 31 can obtain input(s) 2 for input to machine-learned model(s) 1. Machine-learned model(s) 1 can process input(s) 2 to generate output(s) 3. Using output(s) 3, model host 31 can return an output payload 34 for responding to input request 33 from client(s) 32. Output payload 34 can include or be based on output(s) 3.

Model host 31 can leverage various other resources and tools to augment the inference task. For instance, model host 31 can communicate with tool interfaces 35 to facilitate tool use by model instance(s) 31-1. Tool interfaces 35 can include local or remote APIs. Tool interfaces 35 can include integrated scripts or other software functionality. Model host 31 can engage online learning interface(s) 36 to facilitate ongoing improvements to machine-learned model(s) 1. For instance, online learning interface(s) 36 can be used within reinforcement learning loops to retrieve user feedback on inferences served by model host 31. Model host 31 can access runtime data source(s) 37 for augmenting input(s) 2 with additional contextual information. For instance, runtime data source(s) 37 can include a knowledge graph 37-1 that facilitates structured information retrieval for information associated with input request(s) 33 (e.g., a search engine service). Runtime data source(s) 37 can include public or private, external or local database(s) 37-2 that can store information associated with input request(s) 33 for augmenting input(s) 2. Runtime data source(s) 37 can include account data 37-3 which can be retrieved in association with a user account corresponding to a client 32 for customizing the behavior of model host 31 accordingly.

Model host 31 can be implemented by one or multiple computing devices or systems. Client(s) 2 can be implemented by one or multiple computing devices or systems, which can include computing devices or systems shared with model host 31.

For example, model host 31 can operate on a server system that provides a machine-learning service to client device(s) that operate client(s) 32 (e.g., over a local or wide-area network). Client device(s) can be end-user devices used by individuals. Client device(s) can be server systems that operate client(s) 32 to provide various functionality as a service to downstream end-user devices.

In some implementations, model host 31 can operate on a same device or system as client(s) 32. Model host 31 can be a machine-learning service that runs on-device to provide machine-learning functionality to one or multiple applications operating on a client device, which can include an application implementing client(s) 32. Model host 31 can be a part of a same application as client(s) 32. For instance, model host 31 can be a subroutine or method implemented by one part of an application, and client(s) 32 can be another subroutine or method that engages model host 31 to perform inference functions within the application. It is to be understood that model host 31 and client(s) 32 can have various different configurations.

Model instance(s) 31-1 can include one or more machine-learned models that are available for performing inference. Model instance(s) 31-1 can include weights or other model components that are stored in persistent storage, temporarily cached, or loaded into high-speed memory. Model instance(s) 31-1 can include multiple instance(s) of the same model (e.g., for parallel execution of more requests on the same model). Model instance(s) 31-1 can include instance(s) of different model(s). Model instance(s) 31-1 can include cached intermediate states of active or inactive model(s) used to accelerate inference of those models. For instance, an inference session with a particular model may generate significant amounts of computational results that can be re-used for future inference runs (e.g., using a KV cache for transformer-based models). These computational results can be saved in association with that inference session so that session can be executed more efficiently when resumed.

Compute resource(s) 31-2 can include one or more processors (central processing units, graphical processing units, tensor processing units, machine-learning accelerators, etc.) connected to one or more memory devices. Compute resource(s) 31-2 can include a dynamic pool of available resources shared with other processes. Compute resource(s) 31-2 can include memory devices large enough to fit an entire model instance in a single memory instance. Compute resource(s) 31-2 can also shard model instance(s) across multiple memory devices (e.g., using data parallelization or tensor parallelization, etc.). This can be done to increase parallelization or to execute a large model using multiple memory devices which individually might not be able to fit the entire model into memory.

Input request 33 can include data for input(s) 2. Model host 31 can process input request 33 to obtain input(s) 2. Input(s) 2 can be obtained directly from input request 33 or can be retrieved using input request 33. Input request 33 can be submitted to model host 31 via an API.

Model host 31 can perform inference over batches of input requests 33 in parallel. For instance, a model instance 31-1 can be configured with an input structure that has a batch dimension. Separate input(s) 2 can be distributed across the batch dimension (e.g., rows of an array). The separate input(s) 2 can include completely different contexts. The separate input(s) 2 can be multiple inference steps of the same task. The separate input(s) 2 can be staggered in an input structure, such that any given inference cycle can be operating on different portions of the respective input(s) 2. In this manner, for instance, model host 31 can perform inference on the batch in parallel, such that output(s) 3 can also contain the batch dimension and return the inference results for the batched input(s) 2 in parallel. In this manner, for instance, batches of input request(s) 33 can be processed in parallel for higher throughput of output payload(s) 34.

Output payload 34 can include or be based on output(s) 3 from machine-learned model(s) 1. Model host 31 can process output(s) 3 to obtain output payload 34. This can include chaining multiple rounds of inference (e.g., iteratively, recursively, across the same model(s) or different model(s)) to arrive at a final output for a task to be returned in output payload 34. Output payload 34 can be transmitted to client(s) 32 via an API.

Online learning interface(s) 36 can facilitate reinforcement learning of machine-learned model(s) 1. Online learning interface(s) 36 can facilitate reinforcement learning with human feedback (RLHF). Online learning interface(s) 36 can facilitate federated learning of machine-learned model(s) 1.

Model host 31 can execute machine-learned model(s) 1 to perform inference for various tasks using various types of data. For example, various different input(s) 2 and output(s) 3 can be used for various different tasks. In some implementations, input(s) 2 can be or otherwise represent image data. Machine-learned model(s) 1 can process the image data to generate an output. As an example, machine-learned model(s) 1 can process the image data to generate an image recognition output (e.g., a recognition of the image data, a latent embedding of the image data, an encoded representation of the image data, a hash of the image data, etc.). As another example, machine-learned model(s) 1 can process the image data to generate an image segmentation output. As another example, machine-learned model(s) 1 can process the image data to generate an image classification output. As another example, machine-learned model(s) 1 can process the image data to generate an image data modification output (e.g., an alteration of the image data, etc.). As another example, machine-learned model(s) 1 can process the image data to generate an encoded image data output (e.g., an encoded and/or compressed representation of the image data, etc.). As another example, machine-learned model(s) 1 can process the image data to generate an upscaled image data output. As another example, machine-learned model(s) 1 can process the image data to generate a prediction output.

In some implementations, the task is a computer vision task. In some cases, input(s) 2 includes pixel data for one or more images and the task is an image processing task. For example, the image processing task can be image classification, where the output is a set of scores, each score corresponding to a different object class and representing the likelihood that the one or more images depict an object belonging to the object class. The image processing task may be object detection, where the image processing output identifies one or more regions in the one or more images and, for each region, a likelihood that region depicts an object of interest. As another example, the image processing task can be image segmentation, where the image processing output defines, for each pixel in the one or more images, a respective likelihood for each category in a predetermined set of categories. For example, the set of categories can be foreground and background. As another example, the set of categories can be object classes. As another example, the image processing task can be depth estimation, where the image processing output defines, for each pixel in the one or more images, a respective depth value. As another example, the image processing task can be motion estimation, where the network input includes multiple images, and the image processing output defines, for each pixel of one of the input images, a motion of the scene depicted at the pixel between the images in the network input.

In some implementations, input(s) 2 can be or otherwise represent natural language data. Machine-learned model(s) 1 can process the natural language data to generate an output. As an example, machine-learned model(s) 1 can process the natural language data to generate a language encoding output. As another example, machine-learned model(s) 1 can process the natural language data to generate a latent text embedding output. As another example, machine-learned model(s) 1 can process the natural language data to generate a translation output. As another example, machine-learned model(s) 1 can process the natural language data to generate a classification output. As another example, machine-learned model(s) 1 can process the natural language data to generate a textual segmentation output. As another example, machine-learned model(s) 1 can process the natural language data to generate a semantic intent output. As another example, machine-learned model(s) 1 can process the natural language data to generate an upscaled text or natural language output (e.g., text or natural language data that is higher quality than the input text or natural language, etc.). As another example, machine-learned model(s) 1 can process the natural language data to generate a prediction output (e.g., one or more predicted next portions of natural language content).

In some implementations, input(s) 2 can be or otherwise represent speech data (e.g., data describing spoken natural language, such as audio data, textual data, etc.). Machine-learned model(s) 1 can process the speech data to generate an output. As an example, machine-learned model(s) 1 can process the speech data to generate a speech recognition output. As another example, machine-learned model(s) 1 can process the speech data to generate a speech translation output. As another example, machine-learned model(s) 1 can process the speech data to generate a latent embedding output. As another example, machine-learned model(s) 1 can process the speech data to generate an encoded speech output (e.g., an encoded and/or compressed representation of the speech data, etc.). As another example, machine-learned model(s) 1 can process the speech data to generate an upscaled speech output (e.g., speech data that is higher quality than the input speech data, etc.). As another example, machine-learned model(s) 1 can process the speech data to generate a textual representation output (e.g., a textual representation of the input speech data, etc.). As another example, machine-learned model(s) 1 can process the speech data to generate a prediction output.

In some implementations, input(s) 2 can be or otherwise represent latent encoding data (e.g., a latent space representation of an input, etc.). Machine-learned model(s) 1 can process the latent encoding data to generate an output. As an example, machine-learned model(s) 1 can process the latent encoding data to generate a recognition output. As another example, machine-learned model(s) 1 can process the latent encoding data to generate a reconstruction output. As another example, machine-learned model(s) 1 can process the latent encoding data to generate a search output. As another example, machine-learned model(s) 1 can process the latent encoding data to generate a reclustering output. As another example, machine-learned model(s) 1 can process the latent encoding data to generate a prediction output.

In some implementations, input(s) 2 can be or otherwise represent statistical data. Statistical data can be, represent, or otherwise include data computed and/or calculated from some other data source. Machine-learned model(s) 1 can process the statistical data to generate an output. As an example, machine-learned model(s) 1 can process the statistical data to generate a recognition output. As another example, machine-learned model(s) 1 can process the statistical data to generate a prediction output. As another example, machine-learned model(s) 1 can process the statistical data to generate a classification output. As another example, machine-learned model(s) 1 can process the statistical data to generate a segmentation output. As another example, machine-learned model(s) 1 can process the statistical data to generate a visualization output. As another example, machine-learned model(s) 1 can process the statistical data to generate a diagnostic output.

In some implementations, input(s) 2 can be or otherwise represent sensor data. Machine-learned model(s) 1 can process the sensor data to generate an output. As an example, machine-learned model(s) 1 can process the sensor data to generate a recognition output. As another example, machine-learned model(s) 1 can process the sensor data to generate a prediction output. As another example, machine-learned model(s) 1 can process the sensor data to generate a classification output. As another example, machine-learned model(s) 1 can process the sensor data to generate a segmentation output. As another example, machine-learned model(s) 1 can process the sensor data to generate a visualization output. As another example, machine-learned model(s) 1 can process the sensor data to generate a diagnostic output. As another example, machine-learned model(s) 1 can process the sensor data to generate a detection output.

In some implementations, machine-learned model(s) 1 can be configured to perform a task that includes encoding input data for reliable and/or efficient transmission or storage (and/or corresponding decoding). For example, the task may be an audio compression task. The input may include audio data and the output may comprise compressed audio data. In another example, the input includes visual data (e.g., one or more images or videos), the output comprises compressed visual data, and the task is a visual data compression task. In another example, the task may comprise generating an embedding for input data (e.g., input audio or visual data). In some cases, the input includes audio data representing a spoken utterance and the task is a speech recognition task. The output may comprise a text output which is mapped to the spoken utterance. In some cases, the task comprises encrypting or decrypting input data. In some cases, the task comprises a microprocessor performance task, such as branch prediction or memory address translation.

In some implementations, the task is a generative task, and machine-learned model(s) 1 can be configured to output content generated in view of input(s) 2. For instance, input(s) 2 can be or otherwise represent data of one or more modalities that encodes context for generating additional content.

In some implementations, the task can be a text completion task. Machine-learned model(s) 1 can be configured to process input(s) 2 that represent textual data and to generate output(s) 3 that represent additional textual data that completes a textual sequence that includes input(s) 2. For instance, machine-learned model(s) 1 can be configured to generate output(s) 3 to complete a sentence, paragraph, or portion of text that follows from a portion of text represented by input(s) 2.

In some implementations, the task can be an instruction following task. Machine-learned model(s) 1 can be configured to process input(s) 2 that represent instructions to perform a function and to generate output(s) 3 that advance a goal of satisfying the instruction function (e.g., at least a step of a multi-step procedure to perform the function). Output(s) 3 can represent data of the same or of a different modality as input(s) 2. For instance, input(s) 2 can represent textual data (e.g., natural language instructions for a task to be performed) and machine-learned model(s) 1 can process input(s) 2 to generate output(s) 3 that represent textual data responsive to the instructions (e.g., natural language responses, programming language responses, machine language responses, etc.). Input(s) 2 can represent image data (e.g., image-based instructions for a task to be performed, optionally accompanied by textual instructions) and machine-learned model(s) 1 can process input(s) 2 to generate output(s) 3 that represent textual data responsive to the instructions (e.g., natural language responses, programming language responses, machine language responses, etc.). One or more output(s) 3 can be iteratively or recursively generated to sequentially process and accomplish steps toward accomplishing the requested functionality. For instance, an initial output can be executed by an external system or be processed by machine-learned model(s) 1 to complete an initial step of performing a function. Multiple steps can be performed, with a final output being obtained that is responsive to the initial instructions.

In some implementations, the task can be a question answering task. Machine-learned model(s) 1 can be configured to process input(s) 2 that represent a question to answer and to generate output(s) 3 that advance a goal of returning an answer to the question (e.g., at least a step of a multi-step procedure to perform the function). Output(s) 3 can represent data of the same or of a different modality as input(s) 2. For instance, input(s) 2 can represent textual data (e.g., natural language instructions for a task to be performed) and machine-learned model(s) 1 can process input(s) 2 to generate output(s) 3 that represent textual data responsive to the question (e.g., natural language responses, programming language responses, machine language responses, etc.). Input(s) 2 can represent image data (e.g., image-based instructions for a task to be performed, optionally accompanied by textual instructions) and machine-learned model(s) 1 can process input(s) 2 to generate output(s) 3 that represent textual data responsive to the question (e.g., natural language responses, programming language responses, machine language responses, etc.). One or more output(s) 3 can be iteratively or recursively generated to sequentially process and accomplish steps toward answering the question. For instance, an initial output can be executed by an external system or be processed by machine-learned model(s) 1 to complete an initial step of obtaining an answer to the question (e.g., querying a database, performing a computation, executing a script, etc.). Multiple steps can be performed, with a final output being obtained that is responsive to the question.

In some implementations, the task can be an image generation task. Machine-learned model(s) 1 can be configured to process input(s) 2 that represent context regarding a desired portion of image content. The context can include text data, image data, audio data, etc. Machine-learned model(s) 1 can be configured to generate output(s) 3 that represent image data that depicts imagery related to the context. For instance, machine-learned model(s) 1 can be configured to generate pixel data of an image. Values for channel(s) associated with the pixels in the pixel data can be selected based on the context (e.g., based on a probability determined based on the context).

In some implementations, the task can be an audio generation task. Machine-learned model(s) 1 can be configured to process input(s) 2 that represent context regarding a desired portion of audio content. The context can include text data, image data, audio data, etc. Machine-learned model(s) 1 can be configured to generate output(s) 3 that represent audio data related to the context. For instance, machine-learned model(s) 1 can be configured to generate waveform data in the form of an image (e.g., a spectrogram). Values for channel(s) associated with pixels of the image can be selected based on the context. Machine-learned model(s) 1 can be configured to generate waveform data in the form of a sequence of discrete samples of a continuous waveform. Values of the sequence can be selected based on the context (e.g., based on a probability determined based on the context).

In some implementations, the task can be a data generation task. Machine-learned model(s) 1 can be configured to process input(s) 2 that represent context regarding a desired portion of data (e.g., data from various data domains, such as sensor data, image data, multimodal data, statistical data, etc.). The desired data can be, for instance, synthetic data for training other machine-learned models. The context can include arbitrary data type(s). Machine-learned model(s) 1 can be configured to generate output(s) 3 that represent data that aligns with the desired data. For instance, machine-learned model(s) 1 can be configured to generate data values for populating a dataset. Values for the data object(s) can be selected based on the context (e.g., based on a probability determined based on the context).

### Example Computing Systems and Devices

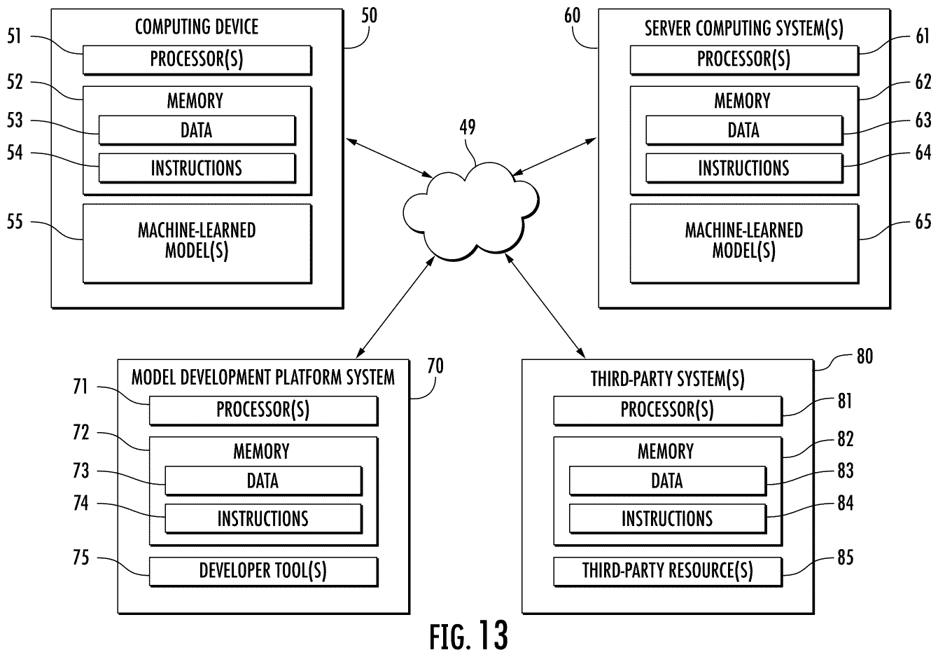

FIG. 13 is a block diagram of an example networked computing system that can perform aspects of example implementations of the disclosure. The system can include a number of computing devices and systems that are communicatively coupled over a network 49. An example computing device 50 is described to provide an example of a computing device that can perform any aspect of the disclosure (e.g., implementing model host 31, client(s) 32, or both). An example server computing system 60 is described as an example of a server computing system that can perform any aspect of the disclosure (e.g., implementing model host 31, client(s) 32, or both). Computing device 50 and server computing system(s) 60 can cooperatively interact (e.g., over network 49) to perform any aspect of the disclosure (e.g., implementing model host 31, client(s) 32, or both). Model development platform system 70 is an example system that can host or serve model development platform(s) 12 for development of machine-learned models. Third-party system(s) 80 are example system(s) with which any of computing device 50, server computing system(s) 60, or model development platform system(s) 70 can interact in the performance of various aspects of the disclosure (e.g., engaging third-party tools, accessing third-party databases or other resources, etc.).

Network 49 can be any type of communications network, such as a local area network (e.g., intranet), wide area network (e.g., Internet), or some combination thereof and can include any number of wired or wireless links. In general, communication over network 49 can be carried via any type of wired or wireless connection, using a wide variety of communication protocols (e.g., TCP/IP, HTTP, SMTP, FTP), encodings or formats (e.g., HTML, XML), or protection schemes (e.g., VPN, secure HTTP, SSL). Network 49 can also be implemented via a system bus. For instance, one or more devices or systems of FIG. 13 can be co-located with, contained by, or otherwise integrated into one or more other devices or systems.

Computing device 50 can be any type of computing device, such as, for example, a personal computing device (e.g., laptop or desktop), a mobile computing device (e.g., smartphone or tablet), a gaming console or controller, a wearable computing device, an embedded computing device, a server computing device, a virtual machine operating on a host device, or any other type of computing device. Computing device 50 can be a client computing device. Computing device 50 can be an end-user computing device. Computing device 50 can be a computing device of a service provided that provides a service to an end user (who may use another computing device to interact with computing device 50).

Computing device 50 can include one or more processors 51 and a memory 52. Processor(s) 51 can be any suitable processing device (e.g., a processor core, a microprocessor, an ASIC, an FPGA, a controller, a microcontroller, etc.) and can be one processor or a plurality of processors that are operatively connected. Memory 52 can include one or more non-transitory computer-readable storage media, such as HBM, RAM, ROM, EEPROM, EPROM, flash memory devices, magnetic disks, etc., and combinations thereof. Memory 52 can store data 53 and instructions 54 which can be executed by processor(s) 51 to cause computing device 50 to perform operations. The operations can implement any one or multiple features described herein. The operations can implement example methods and techniques described herein.

Computing device 50 can also include one or more input components that receive user input. For example, a user input component can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, camera, LIDAR, a physical keyboard or other buttons, or other means by which a user can provide user input.

Computing device 50 can store or include one or more machine-learned models 55. Machine-learned models 55 can include one or more machine-learned model(s) 1, such as a sequence processing model 4. Machine-learned models 55 can include one or multiple model instance(s) 31-1. Machine-learned model(s) 55 can be received from server computing system(s) 60, model development platform system 70, third party system(s) 80 (e.g., an application distribution platform), or developed locally on computing device 50. Machine-learned model(s) 55 can be loaded into memory 52 and used or otherwise implemented by processor(s) 51. Computing device 50 can implement multiple parallel instances of machine-learned model(s) 55.

Server computing system(s) 60 can include one or more processors 61 and a memory 62. Processor(s) 61 can be any suitable processing device (e.g., a processor core, a microprocessor, an ASIC, an FPGA, a controller, a microcontroller, etc.) and can be one processor or a plurality of processors that are operatively connected. Memory 62 can include one or more non-transitory computer-readable storage media, such as HBM, RAM, ROM, EEPROM, EPROM, flash memory devices, magnetic disks, etc., and combinations thereof. Memory 62 can store data 63 and instructions 64 which can be executed by processor(s) 61 to cause server computing system(s) 60 to perform operations. The operations can implement any one or multiple features described herein. The operations can implement example methods and techniques described herein.

In some implementations, server computing system 60 includes or is otherwise implemented by one or multiple server computing devices. In instances in which server computing system 60 includes multiple server computing devices, such server computing devices can operate according to sequential computing architectures, parallel computing architectures, or some combination thereof.

Server computing system 60 can store or otherwise include one or more machine-learned models 65. Machine-learned model(s) 65 can be the same as or different from machine-learned model(s) 55. Machine-learned models 65 can include one or more machine-learned model(s) 1, such as a sequence processing model 4. Machine-learned models 65 can include one or multiple model instance(s) 31-1. Machine-learned model(s) 65 can be received from computing device 50, model development platform system 70, third party system(s) 80, or developed locally on server computing system(s) 60. Machine-learned model(s) 65 can be loaded into memory 62 and used or otherwise implemented by processor(s) 61. Server computing system(s) 60 can implement multiple parallel instances of machine-learned model(s) 65.

In an example configuration, machine-learned models 65 can be included in or otherwise stored and implemented by server computing system 60 to establish a client-server relationship with computing device 50 for serving model inferences. For instance, server computing system(s) 60 can implement model host 31 on behalf of client(s) 32 on computing device 50. For instance, machine-learned models 65 can be implemented by server computing system 60 as a portion of a web service (e.g., remote machine-learned model hosting service, such as an online interface for performing machine-learned model operations over a network on server computing system(s) 60). For instance, server computing system(s) 60 can communicate with computing device 50 over a local intranet or internet connection. For instance, computing device 50 can be a workstation or endpoint in communication with server computing system(s) 60, with implementation of machine-learned models 65 being managed by server computing system(s) 60 to remotely perform inference (e.g., for runtime or training operations), with output(s) returned (e.g., cast, streamed, etc.) to computing device 50. Machine-learned models 65 can work cooperatively or interoperatively with machine-learned models 55 on computing device 50 to perform various tasks.

Model development platform system(s) 70 can include one or more processors 71 and a memory 72. Processor(s) 71 can be any suitable processing device (e.g., a processor core, a microprocessor, an ASIC, an FPGA, a controller, a microcontroller, etc.) and can be one processor or a plurality of processors that are operatively connected. Memory 72 can include one or more non-transitory computer-readable storage media, such as HBM, RAM, ROM, EEPROM, EPROM, flash memory devices, magnetic disks, etc., and combinations thereof. Memory 72 can store data 73 and instructions 74 which can be executed by processor(s) 71 to cause model development platform system(s) 70 to perform operations. The operations can implement any one or multiple features described herein. The operations can implement example methods and techniques described herein. Example operations include the functionality described herein with respect to model development platform 12. This and other functionality can be implemented by developer tool(s) 75.

Third-party system(s) 80 can include one or more processors 81 and a memory 82. Processor(s) 81 can be any suitable processing device (e.g., a processor core, a microprocessor, an ASIC, an FPGA, a controller, a microcontroller, etc.) and can be one processor or a plurality of processors that are operatively connected. Memory 82 can include one or more non-transitory computer-readable storage media, such as HBM, RAM, ROM, EEPROM, EPROM, flash memory devices, magnetic disks, etc., and combinations thereof. Memory 82 can store data 83 and instructions 84 which can be executed by processor(s) 81 to cause third-party system(s) 80 to perform operations. The operations can implement any one or multiple features described herein. The operations can implement example methods and techniques described herein. Example operations include the functionality described herein with respect to tools and other external resources called when training or performing inference with machine-learned model(s) 1, 4, 16, 20, 55, 65, etc. (e.g., third-party resource(s) 85).

FIG. 13 illustrates one example arrangement of computing systems that can be used to implement the disclosure. Other computing system configurations can be used as well. For example, in some implementations, one or both of computing system 50 or server computing system(s) 60 can implement all or a portion of the operations of model development platform system 70. For example, computing system 50 or server computing system(s) 60 can implement developer tool(s) 75 (or extensions thereof) to develop, update/train, or refine machine-learned models 1, 4, 16, 20, 55, 65, etc. using one or more techniques described herein with respect to model alignment toolkit 17. In this manner, for instance, computing system 50 or server computing system(s) 60 can develop, update/train, or refine machine-learned models based on local datasets (e.g., for model personalization/customization, as permitted by user data preference selections).

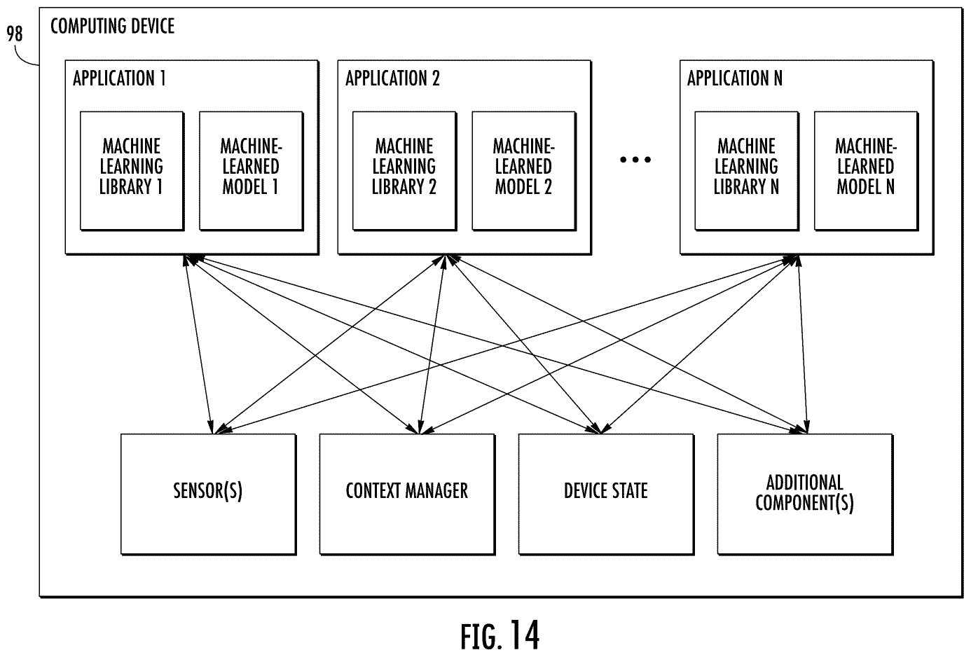

FIG. 14 is a block diagram of an example computing device 98 that performs according to example embodiments of the disclosure. Computing device 98 can be a user computing device or a server computing device (e.g., computing device 50, server computing system(s) 60, etc.). Computing device 98 can implement model host 31. For instance, computing device 98 can include a number of applications (e.g., applications 1 through N). Each application can contain its own machine learning library and machine-learned model(s). For example, each application can include a machine-learned model. Example applications include a navigation application, a content generation application, a text messaging application, an email application, a dictation application, a virtual keyboard application, a browser application, a social media application, a chat application, etc. As illustrated in FIG. 14, each application can communicate with a number of other components of the computing device, such as, for example, one or more sensors, a context manager, a device state component, or additional components. In some implementations, each application can communicate with each device component using an API (e.g., a public API). In some implementations, the API used by each application is specific to that application.

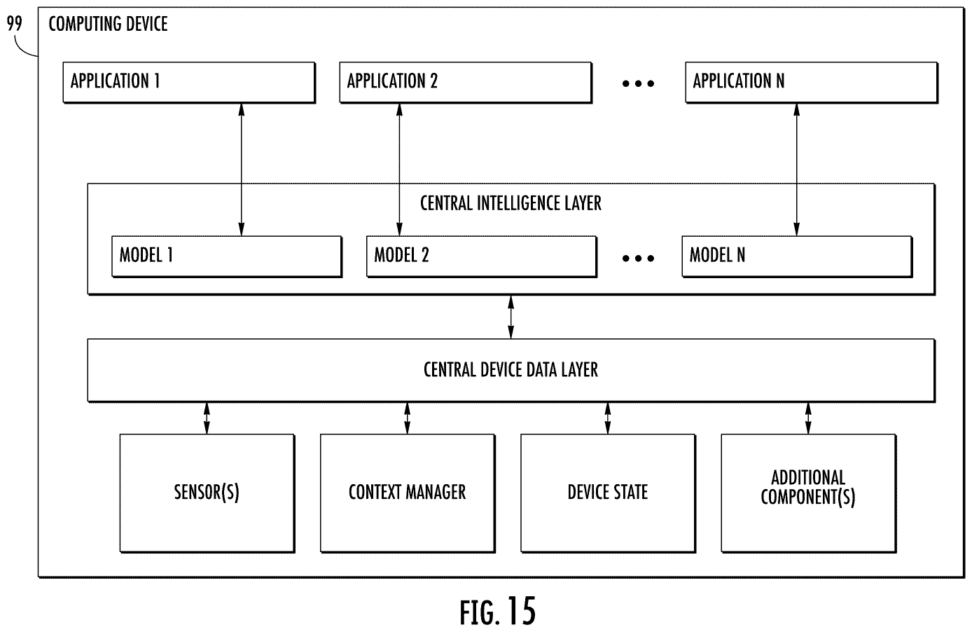

FIG. 15 is a block diagram of an example computing device 99 that performs according to example embodiments of the disclosure. Computing device 99 can be the same as or different from computing device 98. Computing device 99 can be a user computing device or a server computing device (e.g., computing device 50, server computing system(s) 60, etc.). Computing device 98 can implement model host 31. For instance, computing device 99 can include a number of applications (e.g., applications 1 through N). Each application can be in communication with a central intelligence layer. Example applications include a navigation application, a content generation application, a text messaging application, an email application, a dictation application, a virtual keyboard application, a browser application, a social media application, a chat application, etc. In some implementations, each application can communicate with the central intelligence layer (and model(s) stored therein) using an API (e.g., a common API across all applications).

The central intelligence layer can include a number of machine-learned models. For example, as illustrated in FIG. 15, a respective machine-learned model can be provided for each application and managed by the central intelligence layer. In other implementations, two or more applications can share a single machine-learned model. For example, in some implementations, the central intelligence layer can provide a single model for all of the applications. In some implementations, the central intelligence layer is included within or otherwise implemented by an operating system of computing device 99.

The central intelligence layer can communicate with a central device data layer. The central device data layer can be a centralized repository of data for computing device 99. As illustrated in FIG. 15, the central device data layer can communicate with a number of other components of the computing device, such as, for example, one or more sensors, a context manager, a device state component, or additional components. In some implementations, the central device data layer can communicate with each device component using an API (e.g., a private API).

### Additional Disclosure

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

Aspects of the disclosure have been described in terms of illustrative embodiments thereof. Any and all features in the following claims can be combined or rearranged in any way possible, including combinations of claims not explicitly enumerated in combination together, as the example claim dependencies listed herein should not be read as limiting the scope of possible combinations of features disclosed herein. Accordingly, the scope of the disclosure is by way of example rather than by way of limitation, and the subject disclosure does not preclude inclusion of such modifications, variations or additions to the disclosure as would be readily apparent to one of ordinary skill in the art. Moreover, terms are described herein using lists of example elements joined by conjunctions such as “and,” “or,” “but,” etc. It should be understood that such conjunctions are provided for explanatory purposes only. Clauses and other sequences of items joined by a particular conjunction such as “or,” for example, can refer to “and/or,” “at least one of”, “any combination of” example elements listed therein, etc. Terms such as “based on” should be understood as “based at least in part on.”

Terms used herein are used to describe the example embodiments and are not intended to limit and/or restrict the disclosure. The singular forms “a,” “an” and “the” are intended to include the plural forms as well, unless the context clearly indicates otherwise. In this disclosure, terms such as “including”, “having”, “comprising”, and the like are used to specify features, numbers, steps, operations, elements, components, or combinations thereof, but do not preclude the presence or addition of one or more of the features, numbers, steps, operations, elements, components, or combinations thereof.

The term “and/or” includes a combination of a plurality of related listed items or any item of the plurality of related listed items. For example, the scope of the expression or phrase “A and/or B” includes the item “A”, the item “B”, and the combination of items “A and B”.

In addition, the scope of the expression or phrase “at least one of A or B” is intended to include all of the following: (1) at least one of A, (2) at least one of B, and (3) at least one of A and at least one of B. Likewise, the scope of the expression or phrase “at least one of A, B, or C” is intended to include all of the following: (1) at least one of A, (2) at least one of B, (3) at least one of C, (4) at least one of A and at least one of B, (5) at least one of A and at least one of C, (6) at least one of B and at least one of C, and (7) at least one of A, at least one of B, and at least one of C.

It will be understood that, although the terms first, second, third, etc., may be used herein to describe various elements, the elements are not limited by these terms. Instead, these terms are used to distinguish one element from another element. For example, without departing from the scope of the disclosure, a first element may be termed as a second element, and a second element may be termed as a first element.

The term “can” should be understood as referring to a possibility of a feature in various implementations and not as prescribing an ability that is necessarily present in every implementation. For example, the phrase “X can perform Y” should be understood as indicating that, in various implementations, X has the potential to be configured to perform Y, and not as indicating that in every instance X must always be able to perform Y. It should be understood that, in various implementations, X might be unable to perform Y and remain within the scope of the disclosure.

The term “may” should be understood as referring to a possibility of a feature in various implementations and not as prescribing an ability that is necessarily present in every implementation. For example, the phrase “X may perform Y” should be understood as indicating that, in various implementations, X has the potential to be configured to perform Y, and not as indicating that in every instance X must always be able to perform Y. It should be understood that, in various implementations, X might be unable to perform Y and remain within the scope of the disclosure.

To the extent terms including “module”, and “unit,” and the like are used herein, these terms may refer to, but are not limited to, a software or hardware component or device, such as a Field Programmable Gate Array (FPGA) or Application Specific Integrated Circuit (ASIC), which performs certain tasks. A module or unit may be configured to reside on an addressable storage medium and configured to execute on one or more processors. Thus, a module or unit may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The functionality provided for in the components and modules/units may be combined into fewer components and modules/units or further separated into additional components and modules.

Aspects of the above-described example embodiments may be recorded in non-transitory computer-readable media including program instructions to implement various operations embodied by a computer. The media may also include, alone or in combination with the program instructions, data files, data structures, and the like. Examples of non-transitory computer-readable media include magnetic media such as hard disks, floppy disks, and magnetic tape; optical media such as CD ROM disks, Blu-Ray disks, and DVDs; magneto-optical media such as optical discs; and other hardware devices that are specially configured to store and perform program instructions, such as semiconductor memory, read-only memory (ROM), random access memory (RAM), flash memory, USB memory, and the like. Examples of program instructions include both machine code, such as produced by a compiler, and files containing higher level code that may be executed by the computer using an interpreter. The program instructions may be executed by one or more processors. The described hardware devices may be configured to act as one or more software modules in order to perform the operations of the above-described embodiments, or vice versa. In addition, a non-transitory computer-readable storage medium may be distributed among computer systems connected through a network and computer-readable codes or program instructions may be stored and executed in a decentralized manner. In addition, the non-transitory computer-readable storage media may also be embodied in at least one application specific integrated circuit (ASIC) or Field Programmable Gate Array (FPGA).

Each block of the flowchart illustrations may represent a unit, module, segment, or portion of code, which comprises one or more executable instructions for implementing the specified logical function(s). It should also be noted that in some alternative implementations, the functions noted in the blocks may occur out of order. For example, two blocks shown in succession may in fact be executed substantially concurrently (simultaneously) or the blocks may sometimes be executed in the reverse order, depending upon the functionality involved.

Further to the descriptions above, a user may be provided with controls allowing the user to make an election as to both if and when systems, programs, or features described herein may enable collection of user information (e.g., information about a user's social network, social actions, or activities, profession, a user's preferences, or a user's current location), and if the user is sent content or communications from a server. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over what information is collected about the user, how that information is used, and what information is provided to the user.

While the disclosure has been described with respect to various example embodiments, each example is provided by way of explanation, not limitation of the disclosure. Those skilled in the art, upon attaining an understanding of the foregoing, can readily produce alterations to, variations of, and equivalents to such embodiments. Accordingly, the disclosure does not preclude inclusion of such modifications, variations and/or additions to the disclosed subject matter as would be readily apparent to one of ordinary skill in the art. For example, features illustrated or described as part of one embodiment can be used with another embodiment to yield a still further embodiment. Thus, it is intended that the disclosure covers such alterations, variations, and equivalents.

What is claimed is:

1. A first computing system, comprising:
a display device;
one or more memories configured to store instructions; and
one or more processors configured to execute the instructions to perform operations, the operations comprising:
selecting, based on whether one or more rendering criteria are satisfied, at least one of the first computing system or a second computing system to perform one or more rendering operations with respect to a plurality of visual elements associated with an interactive three-dimensional (3D) scene of a location, to generate a plurality of rendered visual elements; and
providing, for presentation via the display device, the interactive 3D scene of the location, based on the plurality of rendered visual elements.

2. The first computing system of claim 1, wherein
the second computing system has a higher processing power than the first computing system,
when the one or more rendering criteria are satisfied, selecting the first computing system to perform the one or more rendering operations; and
when the one or more rendering criteria are not satisfied, selecting the second computing system to perform the one or more rendering operations, and receiving, from the second computing system, the plurality of rendered visual elements from the second computing system.

3. The first computing system of claim 1, wherein
providing, for presentation via the display device, the interactive 3D scene of the location, based on the plurality of rendered visual elements comprises providing a user interface including the interactive 3D scene of the location and at least one selectable user interface element configured to control a view of the interactive 3D scene of the location,
the one or more rendering criteria includes whether the at least one selectable user interface element is selected, and
in response to receiving a selection of the at least one selectable user interface element, selecting the second computing system to perform one or more subsequent rendering operations.

4. The first computing system of claim 1, wherein
the one or more rendering criteria includes whether a size of information associated with the interactive 3D scene to be rendered is greater than a threshold level, and
in response to determining the size of the information associated with the interactive 3D scene to be rendered is greater than the threshold level, selecting the second computing system to initially perform the one or more rendering operations with respect to the plurality of visual elements associated with the interactive 3D scene of the location while the information associated with the interactive 3D scene is transmitted from the second computing system to the first computing system, and
in response to completion of the information associated with the interactive 3D scene being transmitted to the first computing system, switching to the first computing system to perform any remaining rendering operations among the one or more rendering operations with respect to the plurality of visual elements associated with the interactive 3D scene of the location.

5. The first computing system of claim 1, wherein
the one or more rendering criteria includes whether a processing power of the first computing system meets processing power criteria,
in response to determining the processing power of the first computing system meets the processing power criteria, selecting the first computing system to perform the one or more rendering operations, and
in response to determining the processing power of the first computing system does not meet the processing power criteria, selecting the second computing system to perform the one or more rendering operations.

6. The first computing system of claim 1, wherein
the one or more rendering criteria includes whether the first computing system stores a 3D graphics library,
in response to determining the first computing system stores the 3D graphics library, selecting the first computing system to perform the one or more rendering operations, and
in response to determining the first computing system does not store the 3D graphics library, selecting the second computing system to perform the one or more rendering operations.

7. The first computing system of claim 1, wherein
the one or more rendering criteria includes whether the second computing system has a particular computing resource available to perform the one or more rendering operations,
in response to determining the second computing system does not have the particular computing resource available to perform the one or more rendering operations, selecting the first computing system to perform the one or more rendering operations, and
in response to determining the second computing system has the particular computing resource available to perform the one or more rendering operations, selecting the second computing system to perform the one or more rendering operations.

8. The first computing system of claim 7, wherein
in response to the particular computing resource subsequently becoming available after determining the second computing system does not have the particular computing resource available to perform the one or more rendering operations, switching to the first computing system to perform any remaining rendering operations among the one or more rendering operations with respect to the plurality of visual elements associated with the interactive 3D scene of the location.

9. The first computing system of claim 7, wherein
the operations further comprise placing a reservation for the particular computing resource in response to determining the second computing system does not have the particular computing resource available to perform the one or more rendering operations, and
in response to the particular computing resource subsequently becoming available according to the reservation, switching to the second computing system to perform any remaining rendering operations among the one or more rendering operations with respect to the plurality of visual elements associated with the interactive 3D scene of the location.

10. The first computing system of claim 7, wherein
the one or more rendering criteria includes whether a network connection condition associated with a network connecting the first computing system and the second computing system meets particular network criteria and whether a size of information associated with the interactive 3D scene to be rendered is greater than a threshold level,
in response to determining the network connection condition meets the particular network criteria or the size of the information associated with the interactive 3D scene to be rendered is less than the threshold level, selecting the first computing system to perform the one or more rendering operations, and
in response to determining the network connection condition does not meet the particular network criteria and the size of the information associated with the interactive 3D scene to be rendered is greater than the threshold level, selecting the second computing system to perform the one or more rendering operations while the information associated with the interactive 3D scene is transmitted from the second computing system to the first computing system.

11. The first computing system of claim 10, wherein
in response to completion of the information associated with the interactive 3D scene being transmitted to the first computing system, switching to the first computing system to perform any remaining rendering operations among the one or more rendering operations.

12. The first computing system of claim 1, wherein
providing, for presentation via the display device, the interactive 3D scene of the location, based on the plurality of rendered visual elements comprises providing a user interface including the interactive 3D scene of the location and at least one selectable user interface element configured to select a fidelity level of the interactive 3D scene of the location to be displayed,
the one or more rendering criteria includes whether the fidelity level selected via the at least one selectable user interface element is greater than a threshold fidelity level, and
in response to the fidelity level selected via the at least one selectable user interface element being greater than the threshold fidelity level, selecting the second computing system to perform the one or more rendering operations.

13. The first computing system of claim 1, wherein
the one or more rendering criteria includes whether a particular frame associated with the interactive 3D scene includes at least some content having a complexity level greater than a threshold complexity level,
in response to determining the particular frame associated with the interactive 3D scene includes at least some content having the complexity level greater than the threshold complexity level, selecting the first computing system to perform the one or more rendering operations for a first portion of the particular frame and selecting the second computing system to perform the one or more rendering operations for a second portion of the particular frame, and
content in the first portion of the particular frame does not have the complexity level greater than the threshold complexity level and content in the second portion of the particular frame has the complexity level greater than the threshold complexity level.

14. A computer-implemented method, comprising:
selecting, by a first computing system comprising one or more processors, based on whether one or more rendering criteria are satisfied, at least one of the first computing system or a second computing system to perform one or more rendering operations with respect to a plurality of visual elements associated with an interactive three-dimensional (3D) scene of a location, to generate a plurality of rendered visual elements; and
providing, for presentation via a display device of the first computing system, the interactive 3D scene of the location, based on the plurality of rendered visual elements.

15. The computer-implemented method of claim 14, wherein providing, for presentation via the display device of the first computing system, the interactive 3D scene of the location, based on the plurality of rendered visual elements comprises providing a user interface including the interactive 3D scene of the location and at least one selectable user interface element configured to control a view of the interactive 3D scene of the location,
the one or more rendering criteria includes whether the at least one selectable user interface element is selected, and
the method comprises in response to receiving a selection of the at least one selectable user interface element, selecting the second computing system to perform one or more subsequent rendering operations.

16. The computer-implemented method of claim 14, wherein
the one or more rendering criteria includes whether a size of information associated with the interactive 3D scene to be rendered is greater than a threshold level, and
the method comprises:
in response to determining the size of the information associated with the interactive 3D scene to be rendered is greater than the threshold level, selecting the second computing system to initially perform the one or more rendering operations with respect to the plurality of visual elements associated with the interactive 3D scene of the location while the information associated with the interactive 3D scene is transmitted from the second computing system to the first computing system, and
in response to completion of the information associated with the interactive 3D scene being transmitted to the first computing system, switching to the first computing system to perform any remaining rendering operations among the one or more rendering operations with respect to the plurality of visual elements associated with the interactive 3D scene of the location.

17. The computer-implemented method of claim 14, wherein
the one or more rendering criteria includes whether a processing power of the first computing system meets processing power criteria, and
the method comprises:
in response to determining the processing power of the first computing system meets the processing power criteria, selecting the first computing system to perform the one or more rendering operations, and
in response to determining the processing power of the first computing system does not meet the processing power criteria, selecting the second computing system to perform the one or more rendering operations.

18. The computer-implemented method of claim 14, wherein
the one or more rendering criteria includes whether the second computing system has a particular computing resource available to perform the one or more rendering operations, and
the method comprises:
in response to determining the second computing system does not have the particular computing resource available to perform the one or more rendering operations, selecting the first computing system to perform the one or more rendering operations, and
in response to determining the second computing system has the particular computing resource available to perform the one or more rendering operations, selecting the second computing system to perform the one or more rendering operations.

19. The computer-implemented method of claim 14, wherein
the one or more rendering criteria includes whether a particular frame associated with the interactive 3D scene includes at least some content having a complexity level greater than a threshold complexity level, and
the method comprises:
in response to determining the particular frame associated with the interactive 3D scene includes at least some content having the complexity level greater than the threshold complexity level, selecting the first computing system to perform the one or more rendering operations for a first portion of the particular frame and selecting the second computing system to perform the one or more rendering operations for a second portion of the particular frame, and
content in the first portion of the particular frame does not have the complexity level greater than the threshold complexity level and content in the second portion of the particular frame has the complexity level greater than the threshold complexity level.

20. A first computing system, comprising:
one or more memories configured to store instructions; and
one or more processors configured to execute the instructions to perform operations, the operations comprising:
determining whether one or more rendering criteria related to performing one or more rendering operations with respect to a plurality of visual elements associated with an interactive three-dimensional (3D) scene of a location, are satisfied;
in response to determining the one or more rendering criteria related to performing the one or more rendering operations are satisfied, selecting a second computing system to perform the one or more rendering operations and transmitting the plurality of visual elements associated with the interactive 3D scene of the location from the first computing system to the second computing system for rendering; and
in response to determining the one or more rendering criteria related to performing the one or more rendering operations are not satisfied, performing, by the first computing system, the one or more rendering operations to generate a plurality of rendered visual elements and transmitting the plurality of rendered visual elements to the second computing system.
